(19) United States
(12) Patent Application Publication
(10) Pub. No.: US 2025/0150828 A1
(43) Pub. Date: May 8, 2025

(54) INFORMATION TRANSMISSION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/833,428

(22) PCT Filed: Jan. 29, 2022
(86) PCT No.: PCT/CN2022/075122

§ 371 Date: Jul. 26, 2024

(51) Int. Cl. H04W 12/106; H04W 12/041; H04W 24/08; H04W 92/18

(52) U.S. Cl. CPC H04W 12/106; H04W 12/041; H04W 24/08; H04W 92/18

(57) ABSTRACT

A method, apparatus, and computer-readable medium for improving the reliability of a wireless communication network. The reliability of the wireless communication network is improved by: determining an integrity protection key of a ranging announcement message according to long-term key information sent from a core network, where the integrity protection key is configured to replace a discovery key for integrity protection of the ranging announcement message in a case where the first UE is unable to obtain the discovery key from a mobile communication network.

### CROSS-REFERENCE TO RELATED APPLICATIONS

The present application is a U.S. National Stage of International Application No. PCT/CN2022/075122, filed on Jan. 29, 2022, the contents of all of which are incorporated herein by reference in their entirety for all purposes.

### BACKGROUND OF THE INVENTION

A ranging service in a cellular mobile communication system is to determine a distance between two user equipments (UEs) and/or the direction of one UE with respect to another UE via direct communication connection.

### SUMMARY OF THE INVENTION

The present disclosure relates to, but is not limited to, the field of wireless communication technology, and in particular, relates to a method and device for transmitting information, a communication device, and a storage medium.

In view of this, a method and device for transmitting information, a communication device, and a storage medium are provided according to examples of the present disclosure.

According to a first aspect of an example of the present disclosure, a method for transmitting information is provided. The method is performed by a first user equipment (UE), which includes:
determining an integrity protection key of a ranging announcement message according to long-term key information sent from a core network, where the integrity protection key is configured to replace a discovery key for integrity protection of the ranging announcement message in a case where the first UE is unable to obtain the discovery key from a mobile communication network.

According to a second aspect of an example of the present disclosure, a method for transmitting information is provided. The method is performed by a core network, which includes:
sending long-term key information to a first UE;
where the long-term key information is configured for the first UE to determine an integrity protection key of a ranging announcement message, and the integrity protection key is configured to replace a discovery key for integrity protection of the ranging announcement message in a case where the first UE is unable to obtain the discovery key from a mobile communication network.

According to a third aspect of an example of the present disclosure, a method for transmitting information is provided. The method is performed by a second UE, which includes:
receiving a ranging announcement message sent form a first UE on a direct link, where the ranging announcement message includes a long-term key identifier of a long-term key, the long-term key identifier is configured for the second UE to determine an integrity protection key of the ranging announcement message, and the integrity protection key is configured to replace a discovery key for integrity protection of the ranging announcement message in a case where the first UE is unable to obtain the discovery key from a mobile communication network.

According to a fourth aspect of an example of the present disclosure, a communication device is provided, which includes one or more processors, a memory, and an executable program stored on the memory and executed by the one or more processors. When running the executable program, the one or more processors execute steps of the method for transmitting information according to the first aspect, the second aspect or the third aspect.

It should be understood that both the foregoing general description and the following detailed description are illustrative and explanatory merely, which do not limit embodiments of the present disclosure.

### BRIEF DESCRIPTION OF DRAWINGS

The drawings herein are incorporated in the description as a constituent part of the description, which illustrate examples of the present disclosure and serve to explain principles of the present disclosure along with the description.

FIG. 1 is a schematic diagram of a ranging process for user equipments (UEs) according to an example;

FIG. 2 is a schematic structural diagram of a wireless communication system according to an example;

FIG. 3a is a schematic diagram of a ranging process for UEs according to another example;

FIG. 3b is a schematic diagram of a ranging process for UEs according to yet another example;

FIG. 3c is a schematic diagram of a ranging process for UEs according to still another example;

FIG. 4 is a schematic flowchart of a method for transmitting information according to an example;

FIG. 5 is a schematic flowchart of a method for transmitting information according to another example;

FIG. 6 is a schematic flowchart of a method for transmitting information according to yet another example;

FIG. 7 is a schematic flowchart of a method for transmitting information according to still another example;

FIG. 8 is a schematic flowchart of a method for transmitting information according to still another example;

FIG. 9 is a schematic flowchart of a method for transmitting information according to still another example;

FIG. 10 is a schematic flowchart of a method for transmitting information according to still another example;

FIG. 11 is a block diagram of a device for transmitting information according to an example;

FIG. 12 is a block diagram of a device for transmitting information according to another example;

FIG. 13 is a block diagram of a device for transmitting information according to yet another example; and

FIG. 14 is a block diagram of a device for transmitting information according to an example.

### DETAILED DESCRIPTION OF THE INVENTION

Description will be made in detail to examples here, instances of which are illustrated in the accompanying drawings. When the following description relates to the accompanying drawings, the same numbers in different accompanying drawings refer to the same or similar elements unless otherwise indicated. The embodiments described in the following examples do not represent all embodiments consistent with the examples of the present disclosure. Rather, they are merely instances of devices and methods consistent with some aspects of the appended examples of the present disclosure.

The terms used in the examples of the present disclosure is for the purpose of describing particular examples merely and are not intended to limit the examples of the present disclosure. As used in the examples of the present disclosure, singular forms “a”, “an” and “the/said” are intended to include plural forms as well, unless otherwise indicated in the context clearly. It should be understood that the term “and/or” as used here refers to and encompasses any or all possible combinations of one or more of associated listed items.

It should be understood that although the terms of “first”, “second”, “third” and the like may be used in the examples of the present disclosure to describe various information, such information should not be limited to these terms. These terms are merely used to distinguish the same type of information from each other. For example, first information may also be referred to as second information, and similarly, second information may also be referred to as first information, without departing from the scope of the examples of the present disclosure. The word “if” as used here may be construed to mean “at the time of”, or “when”, or “in response to determining”, depending on the context.

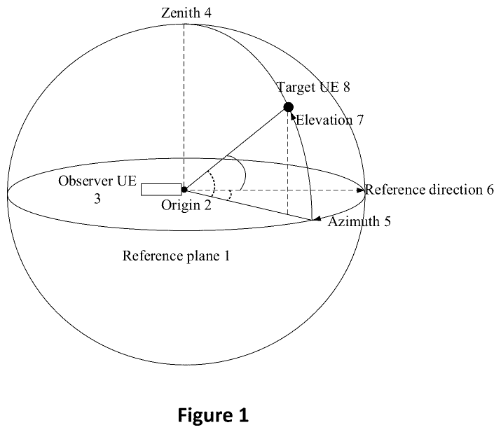

As shown in FIG. 1, observer UE 3, i.e., a ranging client or a ranging requester requesting ranging, has a reference plane 1 and a reference direction 6. The direction of a target UE 8 to the observer UE 3 is the angle between the line connecting the observer UE 3 and the target UE 8 and the reference direction 6. It is represented by an azimuth 5 angle direction and an elevation 7 angle direction. The azimuth 5 angle of the target UE 8 is the angle formed between the reference direction 6 and the line connecting the observer UE 3 and the target UE 8 projected on the same plane as the reference direction 6 orthogonal to the zenith 4. The elevation 7 angle direction of the target UE 8 is the angle above the horizontal plane.

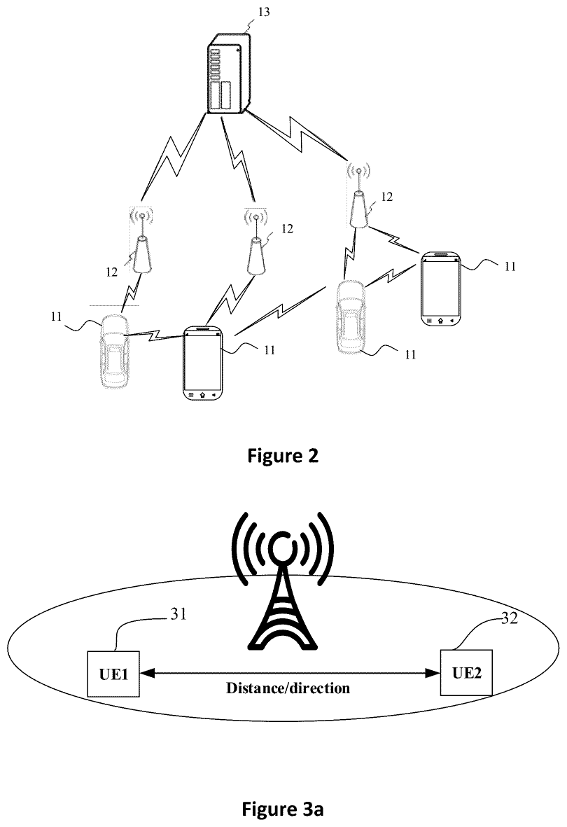

Referring to FIG. 2, a schematic structural diagram of a wireless communication system provided according to an example of the present disclosure is shown. As shown in FIG. 2, the wireless communication system is a communication system based on a cellular mobile communication technology. The wireless communication system may include: one or more terminals 11 and one or more base stations 12.

The terminal 11 may be a device that provides speech and/or data communication for a user. The terminal 11 may communicate with one or more core networks via a radio access network (RAN). The terminal 11 may be an Internet of Things terminal, for example, a sensor device, a mobile telephone (or referred to as a “cellular” telephone), and a computer having an Internet of Things terminal, for example, may be a stationary, portable, pocket-sized, hand-held, computer-built, or vehicle-mounted device, for example, a station (STA), a subscriber unit, a subscriber station, a mobile station, a mobile, a remote station, an access point, a remote terminal, an access terminal, a user terminal, a user agent, a user device, or user equipment (UE). In an example, the terminal 11 may be a device of an unmanned aerial vehicle. In an example, the terminal 11 may be a vehicle-mounted device, for example, a trip computer with a wireless communication function, or a wireless communication device to which a trip computer is externally connected. In an example, the terminal 11 may be a roadside device, for example, a street lamp, a signal lamp, another roadside device and the like with the wireless communication function.

The base station 12 may be a network side device in the wireless communication system. The wireless communication system may be the 4th generation mobile communication (4G) system, also referred to as a long term evolution (LTE) system. In an example, the wireless communication system may also be a 5G system, also referred to as a new radio (NR) system or a 5G NR system. In an example, the wireless communication system may also be a next generation system consecutive to the 5G system. An access network in the 5G system may be referred to as a new generation-radio access network (NG-RAN). In an example, the wireless communication system may be a machine-type communication (MTC) system.

The base station 12 may be an evolved Node B (eNB) used in a 4G system. In an example, the base station 12 may also be a next-generation Node B (gNB) using a central distributed architecture in a 5G system. When the base station 12 uses the central distributed architecture, it generally includes a central unit (CU) and at least two distributed units (DU). The central unit is provided with protocol stacks of a packet data convergence protocol (PDCP) layer, a radio link control (RLC) layer and a media access control (MAC) layer; and each distributed unit is provided with a protocol stack of a physical (PHY) layer. Examples of the present disclosure are not limited to the specific implementation modes of the base station 12.

The wireless connection may be established between the base station 12 and the terminal 11 via a radio air interface. In different embodiments, the radio air interface is a radio air interface based on a 4th generation mobile communication network technology (4G) standard; In an example, the radio air interface is a radio air interface based on a 5th generation mobile communication network technology (5G) standard, for example, the radio air interface is a new radio. For example, the radio air interface may also be a radio air interface based on a 5G-based next generation mobile communication network technology standard.

In some examples, an end to end (E2E) connection may also be established between the terminals 11, for example, vehicle to vehicle (V2V) communication, vehicle to infrastructure (V2I) communication, vehicle to pedestrian (V2P) communication and the like of vehicle to everything (V2X) communication.

In some examples, the above wireless communication system may further include a network management device 13.

One or more base stations 12 are connected to the network management device 13 respectively. The network management device 13 may be a core network device in the wireless communication system. For example, the network management device 13 may be a mobility management entity (MME) in an evolved packet core (EPC). In an example, the network management device may be another core network device, for example, a serving gateway (SGW), a public data network gateway (PGW), a policy and charging rules function (PCRF), a home subscriber server (HSS), etc. The implementation form of the network management device 13 is not limited in the examples of the present disclosure.

The execution body related to the examples of the present disclosure includes, but is not limited to, UE such as a mobile phone terminal in a cellular mobile communication system, a network side device such as a base station and other access network devices, and a core network, etc.

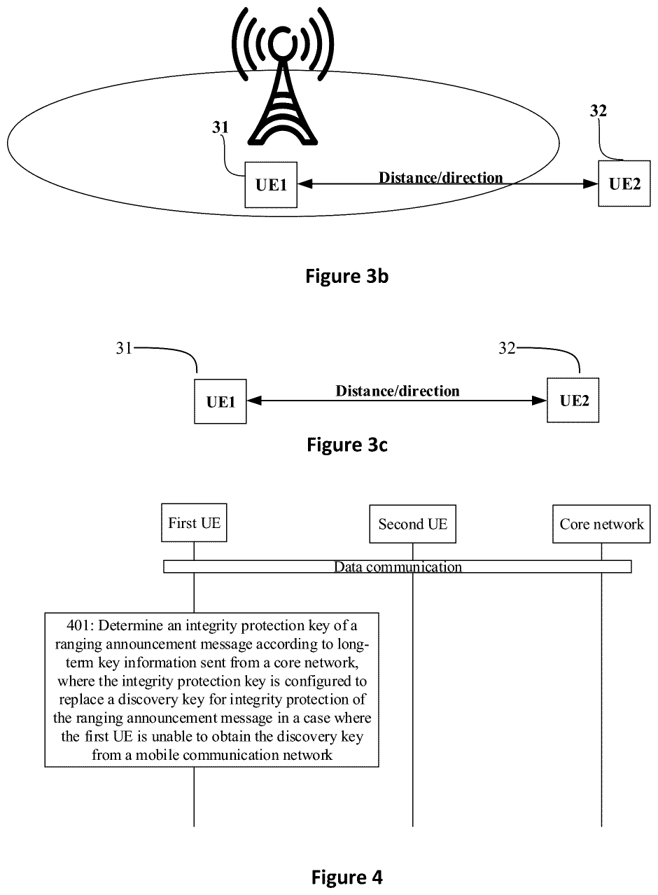

In a 5G cellular mobile communication system, ranging services can be performed regardless of whether there is coverage of 5G signals. As shown in FIG. 3a, ranging is performed with two UE (e.g., UE1 31 and UE2 32) under the coverage of 5G signals. As shown in FIG. 3b, ranging is performed with one (e.g., UE1 31) of the two UE under the coverage of 5G signals. As shown in FIG. 3c, ranging is performed with the two UE (e.g., UE1 31 and UE2 32) outside the coverage of 5G signals.

Before ranging target UE, observer UE needs to detect and identify nearby target UE by using a ranging open discovery message. In a process of ranging open discovery without security protection, the ranging open discovery message may be tampered or replayed by an attacker. When both the observer UE and the target UE are within coverage of the mobile communication network such as 5G (as shown in FIG. 3a), a network function of the mobile communication network may help protect the ranging open discovery message by providing a discovery key for ranging participants (the observer UE and the target UE). The discovery key is time-sensitive, that is, the discovery key will become invalid when it expires. The network function can re-provide a discovery key for alignment and update. However, in some mobile communication network coverage scenarios (as shown in FIG. 3b), when ranging-enabled UE (e.g., the second UE, UE2 32, in FIG. 3b) has an expired ranging discovery key but is not covered by the mobile communication network, the integrity of the ranging open discovery message cannot be protected because the discovery key cannot be updated.

Thus, when the UE is outside the coverage of the mobile communication network and cannot update the discovery key, how to guarantee the integrity of the ranging open discovery message is an urgent problem to be solved.

As shown in FIG. 4, a method for transmitting information is provided according to an example of the present disclosure. The method may be performed by first user equipment (UE) of a cellular mobile communication system. The method includes as follows.
Step 401, an integrity protection key of a ranging announcement message is determined according to long-term key information sent from a core network. The integrity protection key is configured to replace a discovery key for integrity protection of the ranging announcement message in a case where the first UE is unable to obtain the discovery key from a mobile communication network

Here, management actions, e.g., generation and distribution for a long-term key (LTK) may be performed by a ranging key management function (RKMF) network element in a core network of a mobile communication network, such as a 5G cellular mobile communication network. The RKMF may send long-term key information to the UE according to a request for ranging from the UE. The long-term key information is unique for each UE requesting a long-term key.

The first UE and the second UE may be the observer UE or the target UE for ranging respectively. For example, the ranging announcement message may be a message sent from the target UE for the observer UE to discover the target UE. The observer UE may monitor the ranging announcement message and respond to the ranging announcement message satisfying a response condition, thus completing discovery of the target UE by the observer UE. The first UE may be a sender of the ranging announcement message, and the second UE may be a receiver of the ranging announcement message. For example, the first UE may be the target UE for ranging, and the second UE may be the observer UE for ranging. For example, the first UE may be the observer UE for ranging, and the second UE may be the target UE for ranging.

The integrity protection of the ranging announcement message may be implemented, for example, by generating unique integrity protection information for the ranging announcement message through an integrity protection algorithm. The integrity protection information may be computed by using a hash function, etc. The integrity protection key may be added in a process of generating the integrity protection information, to achieve security protection of the integrity protection information. For example, the integrity protection key may be added to the ranging announcement message to generate encrypted integrity protection information before the integrity protection algorithm is used. In an example, the integrity protection key may be used to encrypt the integrity protection information after the integrity protection algorithm is used to generate the integrity protection information.

Here, the integrity protection key may be determined according to the discovery key or determined according to the long-term key information. The discovery key may be a key used by the first UE to send the ranging announcement message when the first UE is connected to the mobile communication network. The discovery key may be directly used as the integrity protection key. However, the discovery key is time-sensitive. In a case where the discovery key expires or fails to update in time, an updated discovery key may be determined according to the long-term key information. In other words, the integrity protection key may be used as an alternative to the updated discovery key.

The long-term key information may be an integrity protection key configured to determine whether integrity protection should be performed on the ranging announcement message when the first UE is unable to use the discovery key.

In an example, the long-term key information at least includes a long-term key. The step of determining an integrity protection key of a ranging announcement message according to long-term key information sent from a core network may include: determine the integrity protection key of the ranging announcement message according to the long-term key.

In an example, the first UE may determine the integrity protection key based on a long-term key and a nonce (i.e., a random number) by using a preset algorithm.

In a case where the first UE remains connection to the mobile communication network, the integrity protection key may be determined by using the discovery key provided by the core network.

In a case where the first UE is unable to obtain the discovery key from the mobile communication network or fails to obtain the discovery key, the integrity protection key may be determined by using the long-term key as an alternative to the discovery key. The first UE may calculate the long-term key by using the preset algorithm to determine the integrity protection key. For example, the integrity protection key is determined by logical operation of the long-term key and the nonce.

The case where the first UE is unable to obtain the discovery key from the mobile communication network may include: the first UE is located outside the mobile communication network causing the inability of obtaining the discovery key and the like.

The case where the first UE fails to obtain the discovery key may include: the core network is unable to respond to the request for obtaining the discovery key from the first UE due to load, etc.

In an example, the case where the first UE is unable to obtain the discovery key from the mobile communication network includes:
the first UE is disconnected from the mobile communication network when the discovery key obtained from the mobile communication network is invalid.

Under the coverage of the mobile communication network, the discovery key sent from the core network to the first UE is time-sensitive. In other words, when the discovery key expires, the discovery key becomes invalid. In a case where the first UE is disconnected from the mobile communication network and the discovery key is invalid, the first UE cannot use the discovery key. The first UE may determine the integrity protection key by using the long-term key to implement integrity protection for the ranging announcement message.

The first UE may receive the long-term key information sent from the core network in the mobile communication network. The long-term key information may be configured for the first UE to determine the long-term key.

In an example, the long-term key information may be, algorithms, parameters and the like, that are used to calculate the long-term key. The first UE may obtain the long-term key information from the core network while maintaining connection to the mobile communication network.

In an example, the long-term key information includes the long-term key and/or the long-term key identifier of the long-term key.

The core network may only send the long-term key to the first UE. The first UE may query the long-term key identifier corresponding to the long-term key from a pre-stored key list. The core network may also only send the long-term key identifier to the first UE. The first UE may query the long-term key corresponding to the long-term key identifier from a pre-stored key list. The key list may be sent to the first UE in advance from the core network, may be agreed upon in advance by a protocol, or may be obtained by the first UE in other ways, which is not limited in the present disclosure. The key list may include a correspondence relationship between a long-term key identifier and a long-term key. Here, the long-term key identifier may be configured to uniquely identify the long-term key.

Optionally, the core network may also send the long-term key and the long-term key identifier of the long-term key to the first UE.

After the core network sends the long-term key information to the first UE, the core network may store the long-term key information.

When the first UE sends the ranging announcement message, the long-term key identifier may be included in the ranging announcement message for the core network, such as the RKMF, to determine the long-term key used by the integrity protection key of the ranging announcement message.

In an example, the core network sends the long-term key information to the first UE via the mobile communication network in response to determining that the first UE has a ranging layer identifier corresponding to the first UE in a ranging layer.

The first UE may send a long-term key request to the core network to request the core network to send information related to the long-term key, such as the long-term key information. The long-term key request may carry a ranging layer identifier corresponding to the first UE. The ranging layer identifier may be configured for the first UE when the first UE performs ranging layer authentication. The ranging layer identifier may be configured for the first UE by the core network, etc. The ranging layer identifier may be configured to indicate that the first UE is authorized to send the ranging announcement message. When the first UE has the ranging layer identifier, it indicates that the first UE is authorized to send the ranging announcement message. The core network may send the long-term key information to the first UE for the first UE to perform integrity protection on the ranging announcement message.

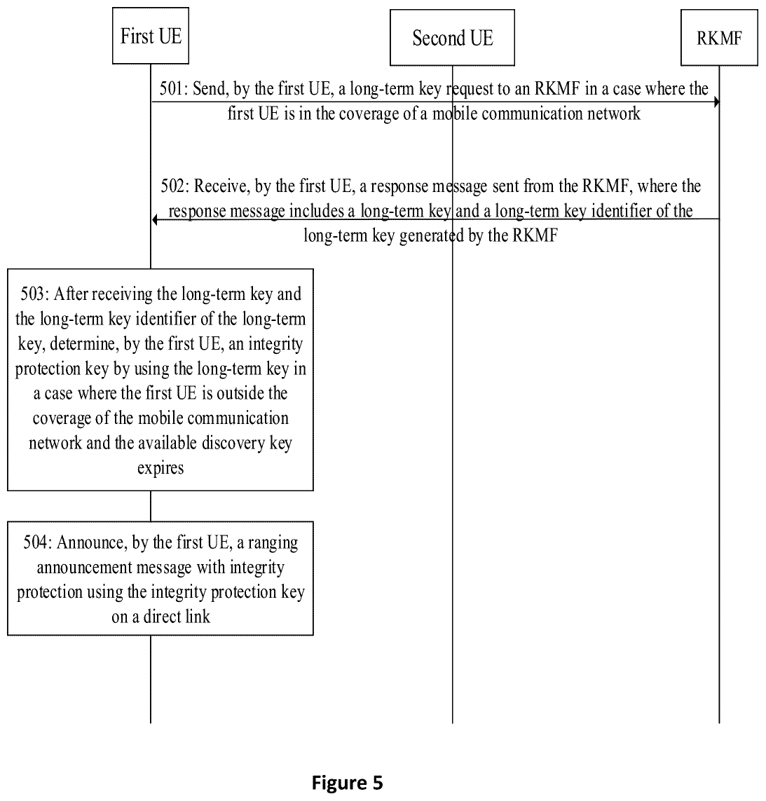

In an example, as shown in FIG. 5, the step of the first UE obtaining the long-term key information from the core network and using the long-term key to perform integrity protection on the ranging announcement message include as follows.
Step 501: the first UE sends a long-term key request to a ranging key management function (RKMF) in a case where the first UE is in the coverage of a mobile communication network.
Step 502: the first UE receives a response message sent from the RKMF when the first UE is in the coverage of the mobile communication network, where the response message includes a long-term key and a long-term key identifier of the long-term key generated by the RKMF. The long-term key identifier is configured to uniquely identify the long-term key.
Step 503: after the first UE receives the long-term key and the long-term key identifier of the long-term key, the first UE may determine an integrity protection key by using the long-term key in a case where the first UE is outside the coverage of the mobile communication network and the available discovery key expires.

In this way, through the long-term key information sent from the core network, the first UE may determine the integrity protection key by using the long-term key information when integrity protection of the ranging announcement message cannot be performed by using the discovery key, thereby enabling the integrity protection of the ranging announcement message. As a result, a data transmission error or tampering of the range announcement message can be discovered timely in the transmission process, which improves the reliability of the transmission of the ranging announcement message.

It should be understood that the above step 503 may be implemented independently or in combination with steps 501 and 502, and an implementation order may be adjusted according to requirements, which is not limited in the present disclosure.

In an example, the step of determining an integrity protection key of a ranging announcement message according to long-term key information sent from a core network includes:
determining an intermediate key based on a long-term key determined by the long-term key information and a nonce; and
determining the integrity protection key according to the intermediate key.

The first UE determines the integrity protection key based on the long-term key and the nonce using a preset algorithm. The first UE may also use a preset algorithm to determine the intermediate key first and then determine the integrity protection key based on the intermediate key.

The first UE may determine the intermediate key according to the long-term key and the nonce using a first sub-algorithm. The first sub-algorithm may be indicated by the core network, may be specified by a communication protocol, or may be agreed between the first UE and the core network.

Here, one or more nonces for determining the intermediate key may be provided. The long-term key and the intermediate key may have a plurality of bits. For example, the long-term key and the intermediate key may each have 256 bits.

In an example, determining the intermediate key (KD) based on the long-term key and the nonce may use, but is not limited to, the following input parameters:

$$FC = 0 \times 58$$

P0=nonce_1 (e.g., ranging layer identifier)
L0=length of nonce_1 (e.g., 0x00 0x03)
P1=nonce_2 (e.g., ranging service code)
L1=length of nonce_2 (e.g., 0x00 0x10)
P2=nonce_3 (optional)
L2=length of nonce_3 (e.g., 0x00 0x10)

In an example, the step of determining the integrity protection key according to the intermediate key includes: determining the integrity protection key according to the intermediate key and the nonce by using a second sub-algorithm.

The nonce used in the process of determining the intermediate key based on the long-term key may be the same as or different from the nonce used in the process of determining the integrity protection key based on the intermediate key.

The first UE may determine the integrity protection key based on the intermediate key by using the second sub-algorithm. The second sub-algorithm may be indicated by the core network, may be specified by a communication protocol, or may be agreed between the first UE and the core network.

In an example, the step of determining the integrity protection key according to the intermediate key includes:
determining a session key based on the intermediate key; and
determining the integrity protection key according to the session key.

The first UE may determine the session key based on the intermediate key by using a third sub-algorithm. The third sub-algorithm may be indicated by the core network or specified by a communication protocol. The third sub-algorithm may include: determining the session key based on the intermediate key and the nonce.

In an example, determining the session key KD-sess based on the intermediate key (KD) may use, but is not limited to, the following input parameters:

$$FC = 0 \times 5 E$$

P0=nonce_4
L0=length of nonce_4 (e.g., 0x00 0x10)
P1=nonce_5 (e.g., ranging service code)
L1=length of nonce_5 (e.g., 0x00 0x10)

The first UE may determine the integrity protection key according to the session key by using a fourth sub-algorithm. The fourth sub-algorithm may be indicated by the core network, may be specified by a communication protocol, or may be agreed between the first UE and the core network.

The fourth sub-algorithm may include: determining the integrity protection key based on the session key and the nonce.

in an example, determining the integrity protection key (also referred to as ranging integrity key, RIK) based on the session key KD-sess may use, but is not limited to, the following input parameters:

$$FC = 0 \times 5 B \\ P 0 = 0 \times 01$$

L0=length of P0 (e.g., 0x00 0x10)
P1=algorithm identifier
L1=length of algorithm identifier (e.g., 0x00 0x10)

Here, an input key should be a 256 bit KD-sess. For an algorithm key with a length of n bits, where n is less than or equal to 256, the n least significant bits of the 256 bits output by KDF shall be used as the algorithm key.

Here, nonces used in the first sub-algorithm, the second sub-algorithm, the third sub-algorithm and/or the fourth sub-algorithm may be same or different. Using different nonces can improve security of determined keys.

Furthermore, the first sub-algorithm, the second sub-algorithm, the third sub-algorithm, and the fourth sub-algorithm may be implemented independently. In an example, some combinations of them may also be selected for implementation according to requirements, which is not limited in the present disclosure.

In an example, the method further includes:
sending, on a direct link, the ranging announcement message with integrity protection using the integrity protection key, where the ranging announcement message at least includes a long-term key identifier of the long-term key and a nonce, and the long-term key identifier is determined according to the long-term key information.

Here, sending, by the first UE, the ranging announcement message on the direct link includes: sending the ranging announcement message on a PC5 port of the direct link.

Here, the long-term key identifier may be configured to uniquely identify the long-term key. The long-term key identifier carried in the ranging announcement message is configured to uniquely identify the long-term key configured to generate the integrity protection key of the ranging announcement message. The nonce carried in the ranging announcement message may be the nonce used in generating the integrity protection key by using the long-term key. One or more nonces are provided.

In an example, the ranging announcement message may carry the nonce used in the first sub-algorithm, the second sub-algorithm, the third sub-algorithm, and/or the fourth sub-algorithm.

The first UE sends the ranging announcement message on the direct link for reception by the second UE. The ranging announcement message may include a ranging requirement, a timestamp and the like, a long-term key identifier, a nonce, etc. Here, the second UE may be the UE that maintains connection to the mobile communication network.

Here, the second UE may monitor and receive the ranging announcement messages on the direct link. The second UE may monitor and receive the ranging announcement messages on the PC5 port of the direct link.

In an example, as shown in FIG. 5, after the first UE obtains the long-term key information from the core network and uses the long-term key to perform integrity protection on the ranging announcement message, the first UE may perform step 504: announcing, by the first UE, the ranging announcement message with integrity protection using the integrity protection key on the direct link.

It should be understood that the above step 504 may be implemented independently or in combination with steps 501 and 502/503, and an implementation order may be adjusted according to requirements, which is not limited in the present disclosure.

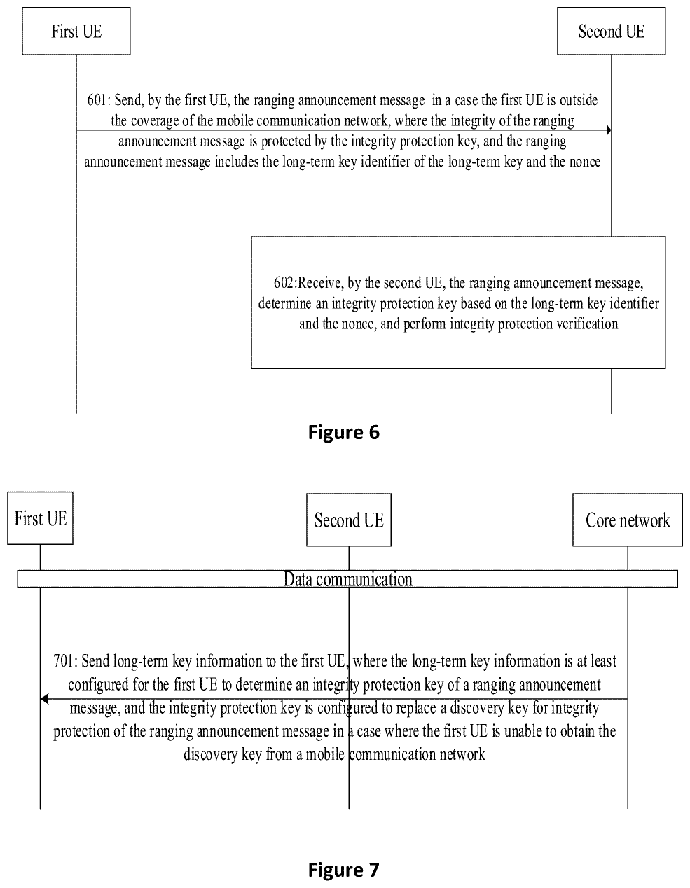

In an example, as shown in FIG. 6, specific steps of sending, by the first UE, the ranging announcement message to the second UE include as follows.
Step 601: in a case where the first UE is outside the coverage of the mobile communication network, the first UE sends the ranging announcement message. The integrity of the ranging announcement message is protected by the integrity protection key. The ranging announcement message includes the long-term key identifier of the long-term key and the nonce.
Step 602: the second UE receives the ranging announcement message, determines the integrity protection key based on the long-term key identifier and the nonce, and performs the Integrity protection verification.

The method for determining the integrity protection key can refer to the foregoing example as shown in FIG. 5, which is not limited in the present disclosure.

The long-term key identifier and the nonce may be used by the second UE to determine the integrity protection key for the ranging announcement message. The second UE may determine the long-term key according to the long-term key identifier. For example, the second UE determines the long-term key through a pre-stored key list or request the long-term key corresponding to the long-term key identifier from the core network. The second UE may determine the integrity protection key from the long-term key and the nonce using the same algorithm as the first UE, thereby performing the integrity verification on the ranging announcement message.

In an example, the nonce in the ranging announcement message may include: one or more nonces used in determining the intermediate key based on the long-term key, i.e., the one or more nonces used in the first sub-algorithm; and/or one or more nonces used in determining the integrity protection key based on the intermediate key, i.e., the one or more nonces used in the second sub-algorithm, the third sub-algorithm, and/or the fourth sub-algorithm.

The first UE may send the ranging announcement message with integrity protection using the integrity protection key on the direct link.

After receiving the ranging announcement message, the second UE may determine the long-term key according to the long-term key identifier in the ranging announcement message. For example, the second UE may determine the long-term key through a pre-stored key list or request the long-term key corresponding to the long-term key identifier from the core network. The second UE may determine the integrity protection key from the long-term key using the same algorithm as the first UE, thereby performing the integrity verification on the ranging announcement message.

The second UE may send the long-term key identifier and the nonce to the core network, such as the RKMF, etc.

The first UE determines that the long-term key of the integrity protection key is sent from the RKMF to the first UE. The RKMF may store the long-term key and the long-term key identifier of the long-term key.

Here, the nonce sent from the second UE to the core network may be a nonce used in determining the intermediate key based on the long-term key.

After receiving the long-term key identifier and the nonce sent from the second UE, the core network may determine the corresponding long-term key according to the long-term key identifier, and determine the intermediate key by using the same algorithm as the first UE used in determining the intermediate key, such as the first sub-algorithm described above.

After determining the intermediate key, the core network may send the intermediate key to the second UE.

After receiving the intermediate key, the second UE may determine the integrity protection key by using the same algorithm as the first UE used in determining the integrity protection key according to the intermediate key, such as the second sub-algorithm described above.

In this way, the second UE determines the integrity protection key for the ranging announcement message.

In an example, the second UE determines the integrity protection key according to the intermediate key, which includes:
determining, by the second UE, a session key based on the intermediate key; and
determining, by the second UE, the integrity protection key according to the session key.

The second UE determines the session key based on the intermediate key and determines the integrity protection key according to the session key in a manner similar to how the first UE determines the session key based on the intermediate key and further determines the integrity protection key, which will not be repeated here.

The algorithm used by the second UE and the first UE to determine each key may be specified by a communication protocol, indicated by the core network, or pre-agreed by the core network and the UEs.

In an example, the ranging announcement message further includes at least one of:
a timestamp of the ranging announcement message sent from the first UE;
an identifier of an integrity protection algorithm for performing integrity protection by using the integrity protection key; and
a ranging requirement.

Here, the timestamp and a replay nonce may be used by the second UE to detect whether the ranging announcement message is replayed. Here, the ranging announcement message may be replayed, which includes: modifying, by a third-party communication device, the ranging announcement message after receiving the ranging announcement message; and sending the ranging announcement message again. The replayed ranging announcement message has the possibility of being maliciously attacked. In a case where the second UE detects that the ranging announcement message is replayed, the ranging announcement message may be discarded.

The second UE may detect the timestamp and the time at which the ranging announcement message is received and determine that the ranging announcement message is replayed in a case where a time difference between the timestamp and the time is greater than a time threshold; otherwise, it may determine that the ranging announcement message is not replayed.

The second UE may store the replay nonce in the ranging announcement message when receiving each ranging announcement message. It may be determined that the ranging announcement message is replayed in a case where the replay nonce in the received ranging announcement message is the same as the stored replay nonce; otherwise, it may be determined that the ranging announcement message is not replayed.

The timestamp and the replay nonce may repeatedly verify whether the ranging announcement message is replayed. In a process of detecting whether the ranging announcement message is replayed by using the timestamp and the replay nonce, it is determined that the ranging announcement message is replayed in a case where either one of the above detections determines that the ranging announcement message is replayed. It may be determined that the ranging announcement message is not replayed in a case where it is determined that the ranging announcement message is not replayed by using the timestamp detection and the replay nonce detection respectively. Here, the nonce for verifying whether the ranging announcement message is replayed may be the nonce used in determining the integrity protection key according to the long-term key. The algorithm identifier may be configured for the second UE to determine the algorithm used by the first UE to calculate the integrity protection key using the long-term key.

In an example, the second UE determines an integrity protection algorithm used by the ranging announcement information according to the identifier of the integrity protection algorithm.

The second UE may perform integrity protection verification on the ranging announcement information based on the integrity protection algorithm and the integrity protection key.

The second UE may perform integrity protection verification on the ranging announcement information based on the integrity protection algorithm and the integrity protection key, which includes:
the second UE may perform integrity protection verification on the ranging announcement information based on the integrity protection algorithm, the integrity protection key, and the nonce for integrity protection.

In an example, the step of sending the ranging announcement message with integrity protection using the integrity protection key on a direct link includes:
sending the ranging announcement message with the integrity protection using the integrity protection key in response to determining that the first UE fails to be connected to the mobile communication network.

Here, the first UE may send the ranging announcement message with the integrity protection using the integrity protection key when failing to be connected to the mobile communication network. The integrity protection key is determined according to the long-term key.

Since the first UE is unable to be connected to the mobile communication network, the discovery key is unable to be updated. The integrity protection key is determined by using the long-term key. And the ranging announcement message with the integrity protection using the integrity protection key determined by the long-term key is sent. In this way, the reliability of the ranging announcement message is improved.

The ranging requirements may include requirements of the first UE on ranging accuracy, time, etc.

In an example, the ranging announcement message further includes a first ranging application code, and the first ranging application code is configured to identify the ranging announcement message.

The first ranging application code may be configured to, but is not limited to, indicate an application type of the ranging announcement message at an application. Only the UE authorized to monitor the ranging announcement message corresponding to the first ranging application code is required to monitor the ranging announcement message including the first ranging application code.

The ranging announcement message may be triggered based on different applications. The first ranging application codes of the ranging announcement message triggered by different types of applications may be different. Here, the first ranging application code is configured in the ranging announcement message by the first UE.

In an example, the second UE sends a monitoring request at least carrying a ranging layer identifier of the second UE in a ranging layer to the core network; and the second UE receives a second ranging application code sent from the core network in response to the monitoring request, where the second ranging application code is configured to indicate the ranging announcement message that is required to be monitored by the second UE.

The ranging layer identifier of the second UE may be configured to uniquely identify the second UE on the ranging layer.

The monitoring request may be configured to request the RKMF to monitor the direct link. Here, monitoring the direct link may include: monitoring the ranging announcement messages on the direct link.

According to the monitoring request of the second UE, the RKMF authorizes the second UE to monitor a specific ranging announcement message according to a service profile defined by the application layer. The RKMF may send the second ranging application code to the second UE to indicate the ranging announcement message that is required to be monitored by the second UE. The RKMF may send the second ranging application code to the second UE in a response to the monitoring request. The RKMF may send one or more second ranging application codes to the second UE.

After receiving the ranging announcement message, the second UE may compare the first ranging application code in the ranging announcement message with the second ranging application code sent from the core network to the second UE. It is determined that the ranging announcement message is the ranging announcement message that is required to be monitored by the second UE in a case where the first ranging application code corresponds to the second ranging application code. The second UE may determine the integrity protection key of the ranging announcement message that is required to be monitored.

When the second UE determines that the received ranging announcement message is the ranging announcement message that is required to be monitored by the second UE, the second UE may send the nonce and the long-term key identifier in the ranging announcement message to the core network, to request the core network to determine the intermediate key.

In an example, the second UE performs integrity verification on the ranging announcement message according to the integrity protection key; and
the second UE determines whether to accept the ranging announcement message according to a result of performing the integrity verification.

The second UE performs integrity verification on the ranging announcement message according to the integrity protection key.

In a case where the integrity verification succeeds, it may be determined that the ranging announcement message is not tampered, or that the ranging announcement message is transmitted correctly, and the second UE may, for example, accept the ranging announcement message, and respond to the ranging announcement message of the first UE, e.g., sending a ranging signal, etc.

In a case where the integrity verification fails, it may be determined that the ranging announcement message is tampered, or that the ranging announcement message is transmitted incorrectly. The second UE may discard the ranging announcement message.

As shown in FIG. 7, a method for transmitting information is provided according to an example. The method may be performed by a core network of a cellular mobile communication system, which includes:
step 701: sending long-term key information to the first UE.

The long-term key information is configured for the first UE to determine the integrity protection key of the ranging announcement message, and the integrity protection key is configured to replace a discovery key for integrity protection of the ranging announcement message in a case where the first UE is unable to obtain the discovery key from a mobile communication network

Here, management actions, e.g., generation and distribution for a long-term key (LTK) may be performed by a ranging key management function (RKMF) network element in a core network of a mobile communication network, such as a 5G cellular mobile communication network. The RKMF may send long-term key information to the UE according to a request for ranging from the UE. The long-term key information is unique for each UE requesting a long-term key.

The first UE and the second UE may be observer UE or target UE for ranging respectively. For example, the ranging announcement message may be a message sent from the target UE for the observer UE to discover the target UE. The observer UE may listen to the ranging announcement message and respond to the ranging announcement message satisfying a response condition, thereby completing the process of the observer UE discovering the target UE. The first UE may be a sender of the ranging announcement message, and the second UE may be a receiver of the ranging announcement message. For example, the first UE may be the target UE for ranging, and the second UE may be the observer UE for ranging. In an example, the first UE may be the observer UE for ranging, and the second UE may be the target UE for ranging.

The integrity protection of the ranging announcement message may be implemented by generating unique integrity protection information for the ranging announcement message through an integrity protection algorithm, etc. The integrity protection information may be calculated by using a hash function, etc. The integrity protection key may be added in a process of generating the integrity protection information, to achieve the security protection of the integrity protection information. For example, the integrity protection key may be added to the ranging announcement message to generate encrypted integrity protection information before using the integrity protection algorithm. In an example, the integrity protection key may be used to encrypt the integrity protection information after generating the integrity protection information by using the integrity protection algorithm.

Here, the integrity protection key may be determined according to the discovery key or determined according to the long-term key information. The discovery key may be a key used by the first UE to send the ranging announcement message when the first UE is connected to the mobile communication network. The discovery key may be used directly as the integrity protection key. However, the discovery key is time-sensitive. When the discovery key is invalid or cannot be updated in time, an updated discovery key may be determined according to the long-term key information, that is, the integrity protection key may be used as an alternative to the updated discovery key.

The long-term key information may be the integrity protection key configured to determine to perform integrity protection on the ranging announcement message when the first UE is unable to use the discovery key.

In an example, the long-term key information at least includes a long-term key. The step of determining the integrity protection key of the ranging announcement message according to long-term key information sent from a core network may include: determine the integrity protection key of the ranging announcement message according to the long-term key.

In an example, the first UE may determine the integrity protection key based on the long-term key and the nonce using a preset algorithm.

In a case where the first UE remains connection to the mobile communication network, the integrity protection key may be determined by using the discovery key provided by the core network.

In a case where the first UE is unable to obtain the discovery key from the mobile communication network or fails to obtain the discovery key, the integrity protection key may be determined by using the long-term key as an alternative to the discovery key. The first UE may calculate the long-term key by using the preset algorithm and the like, to determine the integrity protection key. For example, the integrity protection key is determined by logical operation(s) of the long-term key and the nonce.

The first UE is unable to obtain the discovery key from the mobile communication network, which may include the case where: the first UE is outside the mobile communication network and thus cannot obtain the discovery key, etc.

The first UE fails to obtain the discovery key, which may include the case where: the core network is unable to respond to the request of the first UE to obtain the discovery key due to load, etc.

In an example, the first UE is unable to obtain a discovery key from the mobile communication network, which may include the case where: the first UE is disconnected from the mobile communication network when the discovery key obtained from the mobile communication network is invalid.

Under the coverage of the mobile communication network, the discovery key sent from the core network to the first UE is time-sensitive. Once the discovery key expires, the discovery key becomes invalid. When the first UE is disconnected from the mobile communication network and the discovery key is invalid, the first UE is unable to use the discovery key. The first UE may determine the integrity protection key by using the long-term key to implement integrity protection for the ranging announcement message.

The first UE may receive the long-term key information sent from the core network in the mobile communication network. The long-term key information may be configured for the first UE to determine the long-term key.

In an example, the long-term key information may be algorithms, parameters, and the like used to calculate the long-term key. The first UE may obtain the long-term key information from the core network while maintaining connection to the mobile communication network.

In an example, the long-term key information includes the long-term key and/or the long-term key identifier of the long-term key.

The core network may only send the long-term key to the first UE. The first UE may query the long-term key identifier corresponding to the long-term key from a pre-stored key list. The core network may also only send the long-term key identifier to the first UE. The first UE may query the long-term key corresponding to the long-term key identifier from a pre-stored key list. The key list may be sent to the first UE in advance from the core network, may be agreed upon in advance by a protocol, or may be obtained by the first UE in other ways, which is not limited in the present disclosure. The key list may include a correspondence relationship between a long-term key identifier and a long-term key. Here, the long-term key identifier may be configured to uniquely identify the long-term key.

Optionally, the core network may also send the long-term key and the long-term key identifier of the long-term key to the first UE.

After the core network sends the long-term key information to the first UE, the core network may store the long-term key information.

When the first UE sends the ranging announcement message, the long-term key identifier may be included in the ranging announcement message for the core network, such as the RKMF, to determine the long-term key used by the integrity protection key of the ranging announcement message.

In an example, the step of sending long-term key information to first UE includes:
sending the long-term key information to the first UE via the mobile communication network in response to determining that the first UE has a ranging layer identifier corresponding to the first UE in a ranging layer.

The first UE may send a long-term key request to the core network. The long-term key request may carry a ranging layer identifier corresponding to the first UE. The ranging layer identifier may be configured for the first UE when the first UE performs ranging layer authentication. The ranging layer identifier may be configured for the first UE by the core network, etc. The ranging layer identifier may be configured to indicate that the first UE is authorized to send the ranging announcement message. When the first UE has the ranging layer identifier, it indicates that the first UE is authorized to send the ranging announcement message. The core network may send the long-term key information to the first UE for the first UE to perform integrity protection on the ranging announcement message.

In this way, through the long-term key information sent from the core network, the first UE may determine the integrity protection key by using the long-term key information when integrity protection of the ranging announcement message cannot be performed by using the discovery key, thereby enabling the integrity protection of the ranging announcement message. As a result, a data transmission error or tampering of the range announcement message can be discovered timely in the transmission process, which improves the reliability of transmission of the ranging announcement message.

In an example, the first UE determines the integrity protection key of the ranging announcement message according to the long-term key information sent from the core network, which includes: determining an intermediate key based on the nonce and the long-term key determined by the long-term key information; and determining the integrity protection key according to the intermediate key.

The first UE determines the integrity protection key based on the long-term key and the nonce using a preset algorithm. The first UE may also use the preset algorithm to determine the intermediate key first, and then determine the integrity protection key from the intermediate key.

The first UE may determine the intermediate key based on the long-term key and the nonce using a first sub-algorithm. The first sub-algorithm may be indicated by the core network, may be specified by a communication protocol, or may be agreed between the first UE and the core network.

Here, one or more nonces for determining the intermediate key may be provided. The long-term key and the intermediate key may have a plurality of bits. For example, the long-term key and the intermediate key may each have 256 bits.

In an example, determining the intermediate key (KD) based on the long-term key and the nonce may use, but is not limited to, the following input parameters:

$$FC = 0 \times 58$$

P0=nonce_1 (e.g., ranging layer identifier)
L0=length of nonce_1 (e.g., 0x00 0x03)
P1=nonce_2 (e.g., ranging service code)
L1=length of nonce_2 (e.g., 0x00 0x10)
P2=nonce_3 (optional)
L2=length of nonce_3 (e.g., 0x00 0x10)

In an example, the step of determining the integrity protection key according to the intermediate key includes: determining the integrity protection key according to the intermediate key and the nonce by using a second sub-algorithm.

The nonce used in the process of determining the intermediate key based on the long-term key may be the same as or different from the nonce used in the process of determining the integrity protection key based on the intermediate key.

The first UE may determine the integrity protection key based on the intermediate key by using the second sub-algorithm. The second sub-algorithm may be indicated by the core network, may be specified by a communication protocol, or may be agreed between the first UE and the core network.

In an example, the step of determining the integrity protection key according to the intermediate key includes:
determining a session key based on the intermediate key; and
determining the integrity protection key based on the session key.

The first UE may determine the session key based on the intermediate key by using a third sub-algorithm. The third sub-algorithm may be indicated by the core network or specified by a communication protocol. The third sub-algorithm may include: determining the session key based on the intermediate key and the nonce.

In an example, determining the session key (KD-sess) based on the intermediate key (KD) may use, but is not limited to, the following input parameters:

$$FC = 0 \times 5 E$$

P0=nonce 4
L0=length of nonce_4 (e.g., 0x00 0x10)
P1=nonce_5 (e.g., ranging service code)
L1=length of nonce_5 (e.g., 0x00 0x10)

The first UE may determine the integrity protection key according to the session key by using a fourth sub-algorithm. The fourth sub-algorithm may be indicated by the core network, may be specified by a communication protocol, or may be agreed between the first UE and the core network.

The fourth sub-algorithm may include: determining the integrity protection key based on the session key and the nonce.

In an example, determining the integrity protection key (RIK) based on the session key KD-sess may use, but is not limited to, the following input parameters:

$$FC = 0 \times 5 B \\ P 0 = 0 \times 01$$

L0=length of P0 (e.g., 0x00 0x10)
P1=algorithm identifier
L1=length of algorithm identifier (e.g., 0x00 0x10)

In this case, an input key should be a 256 bit KD-sess. For an algorithm key with a length of n bits, where n is less than or equal to 256, the n least significant bits of the 256 bits outputted by KDF shall be used as the algorithm key.

Here, nonces used in the first sub-algorithm, the second sub-algorithm, the third sub-algorithm and/or the fourth sub-algorithm may be the same or different. Using different nonces can improve security of determined keys.

Further, the first sub-algorithm, the second sub-algorithm, the third sub-algorithm, and the fourth sub-algorithm may be implemented independently. In an example, some combinations of them may also be selected for implementation according to requirements, which is not limited in the present disclosure.

After determining the ranging announcement message, the first UE sends the ranging announcement message with the integrity protection using the integrity protection key on a direct link. The ranging announcement message at least includes a long-term key identifier of the long-term key and the nonce, and the long-term key identifier is determined according to the long-term key information.

Here, the first UE sends the ranging announcement message on the direct link, which may include: sending the ranging announcement message on a PC5 port of the direct link.

Here, the long-term key identifier may be configured to uniquely identify the long-term key. The long-term key identifier carried in the ranging announcement message is configured to uniquely identify the long-term key configured to generate the integrity protection key of the ranging announcement message. The nonce carried in the ranging announcement message may be the nonce used in generating the integrity protection key by using the long-term key. One or more nonces may be provided.

In an example, the ranging announcement message may carry the nonce used in the first sub-algorithm, the second sub-algorithm, the third sub-algorithm, and/or the fourth sub-algorithm.

The first UE sends the ranging announcement message on the direct link for the second UE to receive. The ranging announcement message may include a ranging requirement, a timestamp, and the like, a long-term key identifier, a nonce, etc. Here, the second UE may be the UE that maintains connection with the mobile communication network.

Here, the second UE may monitor and receive the ranging announcement messages on the direct link. The second UE may monitor and receive the ranging announcement messages on the PC5 port of the direct link.

In an example, the method further includes:
receiving a long-term key identifier and a nonce sent from second UE via the mobile communication network;
determining an intermediate key based on a long-term key corresponding to the long-term key identifier and the nonce; and
sending the intermediate key to the second UE via the mobile communication network.

The second UE may send the nonce and the long-term key identifier in the ranging announcement message to the core network, e.g., the RKMF, etc.

The first UE determines that the long-term key of the integrity protection key is sent from the RKMF to the first UE. And the RKMF may store the long-term key and the long-term key identifier of the long-term key.

Here, the nonce sent from the second UE to the core network may be the nonce used in determining the intermediate key based on the long-term key.

After receiving the long-term key identifier and the nonce sent from the second UE, the core network may determine the corresponding long-term key according to the long-term key identifier, and determine the intermediate key by using the same algorithm as the first UE used to determine the intermediate key, e.g., the first sub-algorithm described above, etc.

After determining the intermediate key, the core network may send the intermediate key to the second UE.

After receiving the intermediate key, the second UE may determine the integrity protection key by using the same algorithm as the first UE used to determine the integrity protection key according to the intermediate key, e.g., the second sub-algorithm described above, etc.

In this way, the second UE determines the integrity protection key for the ranging announcement message.

In an example, the second UE determines the integrity protection key according to the intermediate key, which includes:
determining, by the second UE, a session key based on the intermediate key; and
determining, by the second UE, the integrity protection key according to the session key.

The second UE determines the session key based on the intermediate key and determines the integrity protection key according to the session key in a manner similar to how the first UE determines the session key based on the intermediate key and further determines the integrity protection key, which will not be repeated here.

The algorithm used by the second UE and the first UE to determine each key may be specified by a communication protocol, indicated by the core network, or pre-agreed by the core network and the UE.

In an example, the method further includes:
receiving a monitoring request that at least carries a ranging layer identifier of the second UE and is sent from the second UE via the mobile communication network; and
sending a second ranging application code to the second UE via the mobile communication network in response to determining that the second UE is allowed to monitor the ranging announcement message based on an application layer rule, where the second ranging application code is configured to indicate the ranging announcement message that is required to be monitored by the second UE.

The ranging layer identifier of the second UE may be configured to uniquely identify the second UE on the ranging layer.

The monitoring request may be configured to request the RKMF to monitor the direct link. Here, monitoring the direct link may include: monitoring the ranging announcement messages on the direct link.

According to the monitoring request of the second UE, the RKMF authorizes the second UE to monitor a specific ranging announcement message according to a service profile defined by the application layer. The RKMF may send the second ranging application code to the second UE to indicate the ranging announcement message that is required to be monitored by the second UE. The RKMF may send the second ranging application code to the second UE in a response to the monitoring request. The RKMF may send one or more second ranging application codes to the second UE.

After receiving the ranging announcement message, the second UE may compare the first ranging application code in the ranging announcement message with the second ranging application code sent from the core network to the second UE. It is determined that the ranging announcement message is the ranging announcement message that is required to be monitored by the second UE in a case where the first ranging application code corresponds to the second ranging application code. The second UE may determine the integrity protection key of the ranging announcement message that is required to be monitored.

When the second UE determines that the received ranging announcement message is the ranging announcement message that is required to be monitored by the second UE, the second UE may send the nonce and the long-term key identifier in the ranging announcement message to the core network, to request the core network to determine the intermediate key.

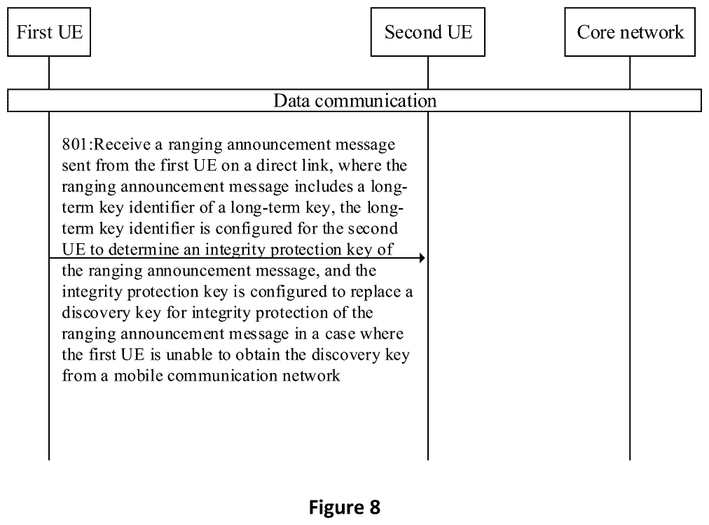

As shown in FIG. 8, a method for transmitting information is provided according to an example. The method may be performed by a second user equipment (UE) of a cellular mobile communication system, which includes:
step 801: receiving a ranging announcement message sent form first UE on a direct link, where the ranging announcement message includes a long-term key identifier of a long-term key, the long-term key identifier is configured for the second UE to determine an integrity protection key of the ranging announcement message, and the integrity protection key is configured to replace a discovery key for integrity protection of the ranging announcement message in a case where the first UE is unable to obtain the discovery key from a mobile communication network.

Here, management actions, e.g., generation and distribution for a long-term key (LTK) may be performed by a ranging key management function (RKMF) network element in a core network of a mobile communication network, such as a 5G cellular mobile communication network. The RKMF may send long-term key information to the UE according to a request for ranging from the UE. The long-term key information is unique for each UE requesting a long-term key.

The first UE and the second UE may be observer UE or target UE for ranging respectively. For example, the ranging announcement message may be a message sent from the target UE for the observer UE to discover the target UE. The observer UE may listen to the ranging announcement message and respond to the ranging announcement message satisfying a response condition, thereby completing the process of the observer UE discovering the target UE. The first UE may be a sender of the ranging announcement message, and the second UE may be a receiver of the ranging announcement message. For example, the first UE may be the target UE for ranging, and the second UE may be the observer UE for ranging. In an example, the first UE may be the observer UE for ranging, and the second UE may be the target UE for ranging.

The integrity protection of the ranging announcement message may be implemented by generating unique integrity protection information for the ranging announcement message through an integrity protection algorithm, etc. The integrity protection information may be calculated by using a hash function, etc. The integrity protection key may be added in a process of generating the integrity protection information, to achieve the security protection of the integrity protection information. For example, the integrity protection key may be added to the ranging announcement message to generate encrypted integrity protection information before using the integrity protection algorithm. In an example, the integrity protection key may be used to encrypt the integrity protection information after generating the integrity protection information by using the integrity protection algorithm.

Here, the integrity protection key may be determined according to the discovery key or determined according to the long-term key information. The discovery key may be a key used by the first UE to send the ranging announcement message when the first UE is connected to the mobile communication network. The discovery key may be directly used as the integrity protection key. However, the discovery key is time-sensitive. In a case where the discovery key is invalid or cannot be updated timely, an updated discovery key may be determined according to the long-term key information, that is, the integrity protection key may be used as an alternative to the updated discovery key.

The long-term key information may be the integrity protection key configured to determine to perform integrity protection on the ranging announcement message when the first UE is unable to use the discovery key.

In an example, the long-term key information at least includes a long-term key. The step of determining the integrity protection key of the ranging announcement message according to long-term key information sent from a core network may include: determining the integrity protection key of the ranging announcement message according to the long-term key.

In an example, the first UE may determine the integrity protection key based on the long-term key and the nonce using a preset algorithm.

In a case where the first UE remains connection to the mobile communication network, the integrity protection key may be determined by using the discovery key provided by the core network.

In a case where the first UE is unable to obtain the discovery key from the mobile communication network or fails to obtain the discovery key, the integrity protection key may be determined by using the long-term key as an alternative to the discovery key. The first UE may calculate the long-term key by using the preset algorithm, etc, to determine the integrity protection key. For example, the integrity protection key is determined by logical operation(s) of the long-term key and the nonce.

The first UE is unable to obtain the discovery key from the mobile communication network which may include the case where: the first UE is outside the mobile communication network and thus cannot obtain the discovery key, etc.

The first UE fails to obtain the discovery key, which may include the case where: the core network is unable to respond to the request of the first UE to obtain the discovery key due to load, etc.

In an example, the first UE is unable to obtain the discovery key from the mobile communication network, which may include the case where: the first UE is disconnected from the mobile communication network when the discovery key obtained from the mobile communication network is invalid.

Under the coverage of the mobile communication network, the discovery key sent from the core network to the first UE is time-sensitive. Once the discovery key expires, the discovery key becomes invalid. When the first UE is disconnected from the mobile communication network and the discovery key is invalid, the first UE is unable to use the discovery key. The first UE may determine the integrity protection key by using the long-term key, to implement the integrity protection for the ranging announcement message.

The first UE may send the ranging announcement message with the integrity protection using the integrity protection key on the direct link.

After receiving the ranging announcement message, the second UE may determine the long-term key according to the long-term key identifier in the ranging announcement message. For example, the long-term key is determined by a pre-stored key list, or the long-term key corresponding to the long-term key identifier is requested from the core network. The second UE may determine the integrity protection key based on the long-term key by using the same algorithm as the first UE, thereby performing the integrity verification on the ranging announcement message.

In this way, through the long-term key information sent from the core network, the first UE may determine the integrity protection key by using the long-term key information when the integrity protection of the ranging announcement message cannot be performed by using the discovery key, thereby enabling the integrity protection of the ranging announcement message. As a result, a data transmission error or tampering of the range announcement message can be discovered in time in the transmission process, which improves the reliability of the transmission of the ranging announcement message.

In an example, the ranging announcement message further includes a nonce, and the method further includes:
sending the long-term key identifier and the nonce to a core network;
receiving, via the mobile communication network, an intermediate key that is sent from the core network in response to the long-term key identifier and the nonce; and
determining the integrity protection key according to the intermediate key.

The first UE determines the integrity protection key based on the long-term key and the nonce by using a preset algorithm. The first UE may also use a preset algorithm to determine the intermediate key first, and then determine the integrity protection key through the intermediate key.

The first UE may determine the intermediate key based on the long-term key and the nonce through a first sub-algorithm. The first sub-algorithm may be indicated by the core network, may be specified by a communication protocol, or may be agreed between the first UE and the core network.

Here, one or more nonces for determining the intermediate key may be provided. The long-term key and the intermediate key may have a plurality of bits. For example, the long-term key and the intermediate key may each have 256 bits.

In an example, determining the intermediate key (KD) based on the long-term key and the nonce may use, but is not limited to the following input parameters:

$$FC = 0 \times 58$$

P0=nonce_1 (e.g., ranging layer identifier)
L0=length of nonce_1 (e.g., 0x00 0x03)
P1=nonce_2 (e.g., ranging service code)
L1=length of nonce_2 (e.g., 0x00 0x10)
P2=nonce_3 (optional)
L2=length of nonce_3 (e.g., 0x00 0x10)

In an example, determining the integrity protection key according to the intermediate key includes: determining the integrity protection key according to the intermediate key and the nonce by using a second sub-algorithm.

The nonce used in the process of determining the intermediate key based on the long-term key may be the same as or different from the nonce used in the process of determining the integrity protection key based on the intermediate key.

The first UE may determine the integrity protection key based on the intermediate key by using the second sub-algorithm. The second sub-algorithm may be indicated by the core network, may be specified by a communication protocol, or may be agreed between the first UE and the core network.

In an example, determining the integrity protection key according to the intermediate key includes:
determining a session key based on the intermediate key; and
determining the integrity protection key according to the session key.

The first UE may determine the session key based on the intermediate key by using a third sub-algorithm. The third sub-algorithm may be indicated by the core network or specified by a communication protocol. The third sub-algorithm may determine the session key based on the intermediate key and the nonce.

In an example, determining the session key KD-sess based on the intermediate key KD may use, but is limited to, the following input parameters:

$$FC = 0 \times 5 E$$

P0=nonce_4
L0=length of nonce_4 (e.g., 0x00 0x10)
P1=nonce_5 (e.g., ranging service code)
L1=length of nonce_5 (e.g., 0x00 0x10)

The first UE may determine the integrity protection key according to the session key by using a fourth sub-algorithm. The fourth sub-algorithm may be indicated by the core network, may be specified by a communication protocol, or may be agreed between the first UE and the core network.

The fourth sub-algorithm may determine the integrity protection key based on the session key and the nonce.

In an example, determining the integrity protection key (RIK) based on the session key KD-sess may use, but is not limited to, the following input parameters:

$$FC = 0 \times 5 B \\ P 0 = 0 \times 01$$

L0=length of P0 (e.g., 0x00 0x10)
P1=algorithm identifier
L1=length of algorithm identifier (e.g., 0x00 0x10)

Here, an input key should be a 256 bit KD-sess. For an algorithm key with a length of n bits, where n is less than or equal to 256, the n least significant bits of the 256 bits outputted by KDF shall be used as the algorithm key.

Here, nonces used in the first sub-algorithm, the second sub-algorithm, the third sub-algorithm and/or the fourth sub-algorithm may be different or the same. Using different nonces can improve the security of determined keys.

Furthermore, the first sub-algorithm, the second sub-algorithm, the third sub-algorithm, and the fourth sub-algorithm may be implemented independently. In an example, some combinations of them may also be selected for implementation according to requirements, which is not limited in the present disclosure.

Here, the first UE sends the ranging announcement message on the direct link, which includes: sending the ranging announcement message on a PC5 port of the direct link.

Here, the long-term key identifier may be configured to uniquely identify the long-term key. The long-term key identifier carried in the ranging announcement message is configured to uniquely identify the long-term key configured to generate the integrity protection key of the ranging announcement message. The nonce carried in the ranging announcement message may be the nonce used in generating the integrity protection key by using the long-term key. One or more nonces are provided.

In an example, the ranging announcement message may carry the one or more nonces used in the first sub-algorithm, the second sub-algorithm, the third sub-algorithm, and/or the fourth sub-algorithm.

The first UE sends the ranging announcement message on the direct link for the second UE to receive. The ranging announcement message may include a ranging requirement, a timestamp, and the like, a long-term key identifier, a nonce, etc. Here, the second UE may be the UE that maintains connection to the mobile communication network.

Here, the second UE may monitor and receive the ranging announcement messages on the direct link. The second UE may monitor and receive the ranging announcement messages on the PC5 port of the direct link.

The long-term key identifier and the nonce may be used for the second UE to determine the integrity protection key for the ranging announcement message. The second UE may determine the long-term key according to the long-term key identifier. For example, the long-term key is determined by a pre-stored key list. Or, the long-term key corresponding to the long-term key identifier is requested from the core network. The second UE may determine the integrity protection key based on the long-term key and the nonce by using the same algorithm as the first UE, thereby performing the integrity verification on the ranging announcement message.

In an example, the nonce in the ranging announcement message may include: one or more nonces used in determining the intermediate key according to the long-term key, i.e., the one or more nonces used in the first sub-algorithm; and/or one or more nonces used in determining the integrity protection key based on the intermediate key, i.e., the one or more nonces used in the second sub-algorithm, the third sub-algorithm, and/or the fourth sub-algorithm.

Here, the nonce in the ranging announcement message may be the nonce used by the first UE to determine the integrity protection key in conjunction with the long-term key. The ranging announcement message may include one or more nonces.

For example, the nonce sent from the core network may include: the nonce used in determining the intermediate key based on the long-term key, and/or the nonce used in determining the integrity protection key based on the intermediate key.

The second UE may send the long-term key identifier and the nonce to the core network, such as the RKM, etc.

The first UE determines that the long-term key of the integrity protection key is sent from the RKMF to the first UE. And the RKMF may store the long-term key and the long-term key identifier of the long-term key.

Here, the nonce sent from the second UE to the core network may be a nonce used in determining the intermediate key according to the long-term key.

After receiving the long-term key identifier and the nonce sent from the second UE, the core network may determine the corresponding long-term key according to the long-term key identifier, and determine the intermediate key by using the same algorithm as the first UE used for determining the intermediate key, e.g., the first sub-algorithm described above.

After determining the intermediate key, the core network may send the intermediate key to the second UE.

After receiving the intermediate key, the second UE may determine the integrity protection key by using the same algorithm as the first UE used for determining the integrity protection key according to the intermediate key, e.g., the second sub-algorithm described above.

In this way, the second UE determines the integrity protection key for the ranging announcement message.

In an example, as shown in FIG. 6, specific steps of the first UE sending the ranging announcement message to the second UE include as follows.
Step 601: in a case where the first UE is outside the coverage of the mobile communication network, the second UE sends the ranging announcement message. The integrity protection of the ranging announcement message is performed by using the integrity protection key. The ranging announcement message includes the long-term key identifier of the long-term key and the nonce.
Step 602: the second UE receives the ranging announcement message and determines an integrity protection key based on the long-term key identifier and the nonce. The integrity protection verification is performed.

The method for determining the integrity protection key may refer to the foregoing examples as shown in FIG. 5, which is not limited in the present disclosure.

In an example, the second UE determines the integrity protection key according to the intermediate key, which includes:
determining, the second UE, a session key based on the intermediate key; and
determining, the second UE, the integrity protection key according to the session key.

The second UE determines the session key based on the intermediate key and determines the integrity protection key according to the session key in a manner similar to how the first UE determines the session key based on the intermediate key and further determines the integrity protection key, which will not be repeated here.

The algorithm used by the second UE and the first UE to determine each key may be specified by a communication protocol, indicated by the core network, or pre-agreed by the core network and the UE.

In an example, the ranging announcement message further includes at least one of:
a timestamp of the ranging announcement message sent from the first UE;
an identifier of an integrity protection algorithm for performing integrity protection by using the integrity protection key; and
a ranging requirement.

Here, the timestamp and a replay nonce may be used by the second UE to detect whether the ranging announcement message is replayed. Here, the ranging announcement message is replayed, which includes the case where: a third-party communication device modifies the ranging announcement message after receiving the ranging announcement message and sends the ranging announcement message again. The replayed ranging announcement message has the possibility of being maliciously attacked. Thus, when the second UE detects that the ranging announcement message is replayed, the ranging announcement message may be discarded.

In an example, the method further includes:
determining whether the ranging announcement message is replayed based on the timestamp and/or the nonce.

The second UE may detect the timestamp and a time at which the ranging announcement message is received and determine that the ranging announcement message is replayed when a time difference between the timestamp and the time is greater than a time threshold; otherwise, determining that the ranging announcement message is not replayed.

The second UE may store the replay nonce in the ranging announcement message when receiving each ranging announcement message. It may be determined that the ranging announcement message is replayed when the replay nonce in the received ranging announcement message is the same as the stored replay nonce; otherwise, it may be determined that the ranging announcement message is not replayed.

The timestamp and the replay nonce may repeatedly verify whether the ranging announcement message is replayed. In a process of detecting whether the ranging announcement message is replayed by using the timestamp and the replay nonce, it is determined that the ranging announcement message is replayed in a case where either one of the above detections determines that the ranging announcement message is replayed. It may be determined that the ranging announcement message is not replayed in a case where it is determined that the ranging announcement message is not replayed by using the timestamp detection and the replay nonce detection respectively. Here, the nonce for verifying whether the ranging announcement message is replayed may be the nonce used in determining the integrity protection key according to the long-term key.

In an example, the second UE determines an integrity protection algorithm used by the ranging announcement information according to the identifier of the integrity protection algorithm.

The second UE may perform the integrity protection verification on the ranging announcement information based on the integrity protection algorithm and the integrity protection key.

The second UE may perform the integrity protection verification on the ranging announcement information based on the integrity protection algorithm and the integrity protection key, which includes as follows.

The second UE may perform the integrity protection verification on the ranging announcement information based on the integrity protection algorithm, the integrity protection key, and the nonce for integrity protection.

The ranging requirements may include requirements of the first UE on ranging accuracy, time, etc.

In an example, the ranging announcement message further includes a first ranging application code. The first ranging application code is configured to identify the ranging announcement message.

The first ranging application code may be configured to, but is not limited to, indicate an application type of the ranging announcement message at an application layer. Only the UE that is authorized to monitor the ranging announcement message corresponding to the first ranging application code can monitor the ranging announcement message including the first ranging application code.

The ranging announcement message may be triggered based on different applications. The first ranging application codes of the ranging announcement message triggered by different types of applications may be different. Here, the first ranging application code is configured in the ranging announcement message by the first UE.

In an example, the method further includes:
sending a monitoring request at least carrying a ranging layer identifier of the second UE in a ranging layer to the core network; and
receiving a second ranging application code sent from the core network in response to the monitoring request, where the second ranging application code is configured to indicate the ranging announcement message that is required to be monitored by the second UE.

The ranging layer identifier of the second UE may be configured to uniquely identify the second UE on the ranging layer.

The monitoring request may be configured to request the RKMF to monitor the direct link. Here, monitoring the direct link may include: monitoring the ranging announcement messages on the direct link.

According to the monitoring request of the second UE, the RKMF authorizes the second UE to monitor a specific ranging announcement message according to a service profile defined by the application layer. The RKMF may send the second ranging application code to the second UE to indicate the ranging announcement message that is required to be monitored by the second UE. The RKMF may send the second ranging application code to the second UE in a response to the monitoring request. The RKMF may send one or more second ranging application codes to the second UE.

In an example, the step of sending the long-term key identifier and the nonce to the core network includes:
sending the long-term key identifier and the nonce to the core network in response to determining that the first ranging application code in the ranging announcement message and the second ranging application code have a correspondence relationship.

After receiving the ranging announcement message, the second UE may compare the first ranging application code in the ranging announcement message with the second ranging application code sent from the core network to the second UE. It is determined that the ranging announcement message is the ranging announcement message that is required to be monitored by the second UE, in a case where the first ranging application code corresponds to the second ranging application code. The second UE may determine the integrity protection key of the ranging announcement message that is required to be monitored.

In a case where the second UE determines that the received ranging announcement message is the ranging announcement message that is required to be monitored by the second UE, the second UE may send the long-term key identifier and the nonce in the ranging announcement message to the core network to request the core network to determine the intermediate key.

In an example, the method further includes:
performing integrity verification on the ranging announcement message according to the integrity protection key; and
determining whether to accept the ranging announcement message based on a result of the integrity verification.

In an example, the second UE performs the integrity verification on the ranging announcement message according to the integrity protection key.

In a case where the integrity verification succeeds, it may be determined that the ranging announcement message is not tampered, or that the ranging announcement message is transmitted correctly. For example, the second UE may accept the ranging announcement message. In this case, the second UE responds to the ranging announcement message of the first UE, e.g., sending a ranging signal, etc.

In a case where the integrity verification fails, it may be determined that the ranging announcement message is tampered, or that the ranging announcement message is transmitted incorrectly. The second UE may discard the ranging announcement message.

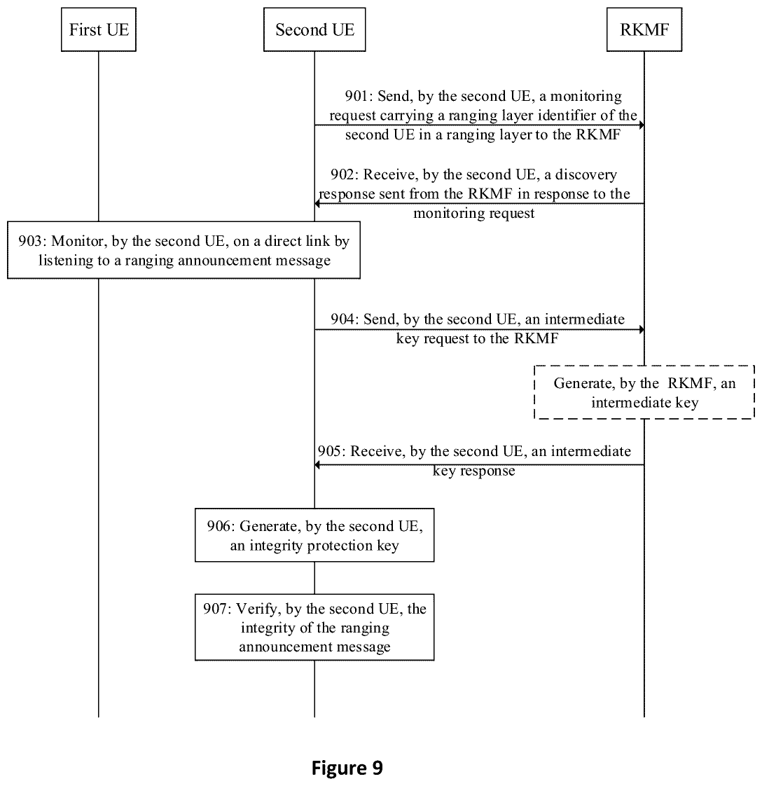

In an example, as shown in FIG. 9, steps of the second UE requesting to monitor the direct link, obtaining the long-term key from the core network, and performing the integrity verification on the ranging announcement message by using the integrity protection key include as follows.
Step 901: the second UE sends a monitoring request (e.g., discovery request) carrying a ranging layer identifier of the second UE in a ranging layer to the core network, to request for monitoring a direct link.
Step 902: the second UE receives a discovery response sent from the core network (RKMF) in response to the monitoring request, where the discovery response includes a second ranging application code (one or more second ranging application codes); and the RKMF authorizes the second UE to monitor a specific ranging announcement message according to a service profile defined by an application layer.
Step 903: the second UE monitors on the direct link by listening to the ranging announcement message.
Step 904: the second UE is located within the mobile communication coverage; after receiving the ranging announcement message sent from the first UE that matches the ranging application code of the second UE, the second UE sends an intermediate key request to the core network (RKMF), where the intermediate key request includes the nonce for generating the intermediate key and the long-term key identifier in the ranging announcement message; the RKMF determines the long-term key according to the long-term key identifier and generates the intermediate key by using the long-term key and the nonce, where the RKMF generates the intermediate key in the same manner as the first UE generates the intermediate key.
Step 905: the second UE receives an intermediate key response, where the intermediate key response includes the intermediate key generated by the RKMF. The RKMF generates the intermediate key in the same manner as the first UE generates the intermediate key.
Step 906: the second UE generates an integrity protection key, where the second UE receives the intermediate key (KD), first generates a session key (KD-sess), and then generates the integrity protection key (RIK). The second UE generates the integrity protection key using the intermediate key in the same manner as the first UE.
Step 907: the second UE verifies the integrity of the ranging announcement message; in a case where the integrity verification fails, the second UE aborts the ranging announcement message of the first UE; in a case where a timestamp and a replay nonce in the ranging announcement message indicate that there is no replay attack, the second UE discovers the correct target UE; otherwise, the second UE aborts the ranging announcement message of the first UE.

A specific example is provided below in conjunction with any one of embodiments described above:

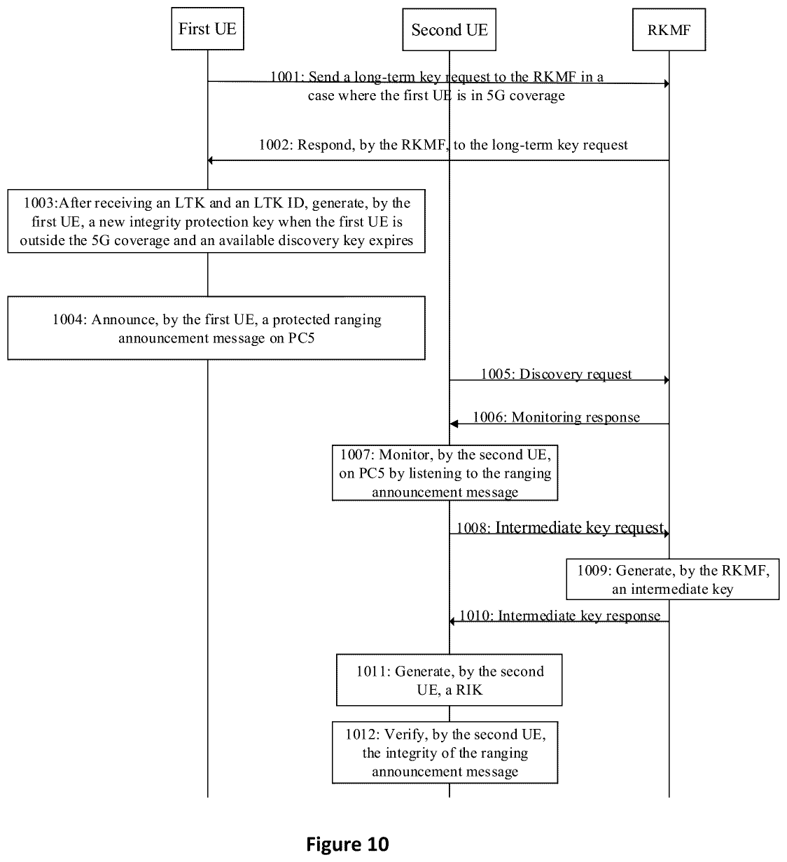

FIG. 10 illustrates a process of secure ranging open discovery in a partial 5G coverage scenario. The first UE, the second UE and the core network may configure security algorithm identifiers in the same manner. For example, the security algorithm identifiers are configured as described in 3GPP TS 33.501. Assuming that the first UE in 5G coverage has been pre-configured by a network or provided with information of target UE that the first UE can discover.

In order to protect traffic between the UE and a ranging key management function (RKMF), the UE and the RKMF shall support security requirements and procedures in the mobile communication network standards (e.g., section 5.2.5 in 3GPP TS 33.503).
Step 1001: in a case where UE is uniquely identified by a ranging layer identifier (ID), when a first UE is still within 5G coverage, the first UE may obtain a long-term key (LTK) from the RKMF;
the first UE may send a long-term key request to the RKMF when the first UE is in the coverage of the mobile communication network.
Step 1002: the RKMF responds to the long-term key request; the RKMF generates and sends the LTK and a long-term key identifier (LTK ID) for the first UE after the RKMF receives an LTK request message, where the LTK ID uniquely identifies the LTK; and the RKMF stores the LTK and the LTK ID locally.
Step 1003: after receiving the LTK and the LTK ID, the first UE generates a new integrity protection key when the first UE is outside the 5G coverage and an available discovery key expires. In an example, the first UE uses a KDF specified in TS 33.220 Annex B. The first UE first generates an intermediate key (KD) from the LTK. The first UE derives a session key (KD-sess) based on the KD. Finally, the integrity protection key (RIK) is derived based on the KD-sess, to protect the integrity of the ranging announcement message.
Step 1004: the first UE announces the protected ranging announcement message on PC5. The ranging announcement message includes a timestamp, ranging application codes, an identifier of a security algorithm for protecting the ranging announcement message, a nonce generated by the first UE for deriving the session key, the LTK ID of the first UE, etc. The integrity of the ranging announcement message is protected by the RIK.
Step 1005: the second UE sends a monitoring request (discovery request). The PC5 is requested to be monitored by sending a ranging layer ID of the second UE to the RKMF.
Step 1006: the RKMF sends a monitoring response; according to the monitoring request of the second UE, the RKMF authorizes the second UE to monitor a specific target according to a service profile defined by the application layer; and the RKMF sends information about a set of valid target ranging application codes to the second UE in the monitoring response.
Step 1007: the second UE performs monitoring on PC5 by listening to the ranging announcement message.
Step 1008: the second UE is located within 5G coverage; after receiving the ranging announcement message sent from the first UE, the second UE send an intermediate key (KD) request. In an example, the second UE sends the LTK ID of the first UE and the nonce for generating the intermediate key KD in the ranging announcement message to the RKMF.
Step 1009: after receiving a discovery key request message of the second UE, the RKMF checks whether the second UE can monitor the first UE according to a service profile; the PRMF aborts the discovery process in a case where the second UE is not authorized to monitor the first UE; and the RKMF calculates the intermediate key KD according to the LTK of the first UE and the nonce in a case where the second UE is authorized to monitor the first UE.
Step 1010: the RKMF sends an intermediate key KD response to the second UE, where the intermediate key KD response includes a new KD generated in the same manner as that generated by the first UE.
Step 1011: the second UE generates an RIK; the second UE receives the intermediate key KD, first generates a KD-sess, and then generates the RIK; and the second UE generates the RIK in the same manner as the first UE generates the RIK according to the KD and the nonce.
Step 1012: the second UE verifies the integrity of the ranging announcement message;
the second UE aborts the ranging announcement message of the first UE in a case where the integrity verification fails; it is determined that the second UE discovers the correct first UE in a case where the timestamp and the nonce in the ranging announcement message indicate that there is no replay attack; otherwise, the second UE aborts the ranging announcement message of the first UE.

An example of determining the key is provided below.

When the KD is calculated from the LTK, the following parameters are used to serve as the input S of the KDF specified in Annex B of 3GPP TS 33.220 [2]:

$$FC = 0 \times 58$$

P0=nonce_1 (e.g., ranging layer identifier)
L0=length of nonce_1 (e.g., 0x00 0x03)
P1=nonce_2 (e.g., ranging service code)
L1=length of nonce_2 (e.g., 0x00 0x10)
P2=nonce_3 (optional)
L2=length of nonce_3 (e.g., 0x00 0x10)

The input LTK is 256 bits.

An example of calculating the KD-sess from the KD is provided below.

When the KD-sess is calculated from the KD, the following parameters are used to serve as the input S of the KDF specified in Annex B of 3GPP TS 33.220 [2]:
FC=0x5E
P0=nonce 4
L0=length of nonce_4 (e.g., 0x00 0x10)
P1=nonce_5 (e.g., ranging service code)
L1=length of nonce_5 (e.g., 0x00 0x10)

The input KD is 256 bits.

An example of calculating the RIK is provided below. When the RIK is calculated from the KD-sess, the following parameters are used to serve as the input S of the KDF specified in Annex B of 3GPP TS 33.220 [2]:

$$FC = 0 \times 5 B \\ P 0 = 0 \times 01 ( if the integrity protection key is being derived )$$

L0=length of P0 (e.g., 0x00 0x10)
P1=algorithm identifier
L1=length of algorithm identifier (e.g., 0x00 0x10)

The algorithm identifier is configured as described in 3GPP TS 33.501 [3].

The input KD-sess is 256 bits.

For an algorithm key with a length of n bits, where n is less than or equal to 256, the n least significant bits of the 256 bits outputted by KDF shall be used as the algorithm key.

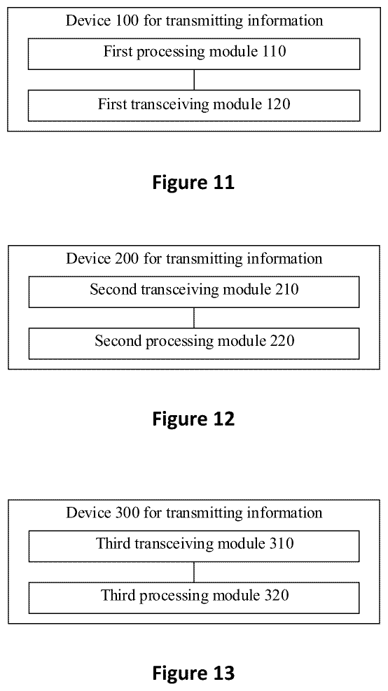

A device for transmitting information is further provided according to an example of the present disclosure. As shown in FIG. 11, the device 100 is applied to a first UE of a cellular mobile wireless communication, which includes:
a first processing module 110, configured to determine an integrity protection key of a ranging announcement message according to long-term key information sent from a core network, where the integrity protection key is configured to replace a discovery key for integrity protection of the ranging announcement message in a case where the first UE is unable to obtain the discovery key from a mobile communication network.

In an example, the first processing module 110 is further configured to:
determine an intermediate key based on a long-term key and a nonce, where the long-term key is determined by the long-term key information; and
determine the integrity protection key according to the intermediate key.

In an example, the device 100 further includes:
a first transceiving module 120, configured to send the ranging announcement message with the integrity protection using the integrity protection key on a direct link, where the ranging announcement message at least includes a long-term key identifier of the long-term key and the nonce, and the long-term key identifier is determined according to the long-term key information.

In an example, the first transceiving module 120 is further configured to:
send the ranging announcement message with the integrity protection using the integrity protection key in response to determining that the first UE fails to be connected to the mobile communication network.

In an example, the ranging announcement message further includes at least one of:
a timestamp of when the first UE sends the ranging announcement message;
an identifier of an integrity protection algorithm for performing the integrity protection by using the integrity protection key; and
a ranging requirement.

In an example, the ranging announcement message further includes a first ranging application code, and the first ranging application code is configured to identify the ranging announcement message.

In an example, the first UE is unable to obtain the discovery key from the mobile communication network, which includes:
the first UE is disconnected from the mobile communication network in a case where the discovery key obtained from the mobile communication network is invalid.

In an example, the long-term key information includes the long-term key and/or the long-term key identifier of the long-term key.

A device for transmitting information is further provided according to an example of the present disclosure. As shown in FIG. 12, the device 200 is applied to a core network of cellular mobile wireless communication, which includes:
a second transceiving module 210, configured to send long-term key information to a first UE;
where the long-term key information is configured for the first UE to determine an integrity protection key of a ranging announcement message, and the integrity protection key is configured to replace a discovery key for integrity protection of the ranging announcement message in a case where the first UE is unable to obtain the discovery key from a mobile communication network.

In an example, the second transceiving module 210 is further configured to receive a long-term key identifier and a nonce sent from a second UE via the mobile communication network.

The device 200 further includes:
a second processing module 220, configured to determine an intermediate key based on a long-term key corresponding to the long-term key identifier and the nonce.

The second transceiving module 210 is further configured to send the intermediate key to the second UE via the mobile communication network.

In an example, the second transceiving module 210 is further configured to:
send the long-term key information to the first UE via the mobile communication network in response to determining that the first UE has a ranging layer identifier corresponding to the first UE in a ranging layer.

In an example, the second transceiving module 210 is further configured to:
receive a monitoring request sent from the second UE via the mobile communication network, where the monitoring request at least carrying a ranging layer identifier of the second UE; and
send a second ranging application code to the second UE via the mobile communication network in response to determining that the second UE is allowed to monitor the ranging announcement message based on an application layer rule, where the second ranging application code is configured to indicate the ranging announcement message that is required to be monitored by the second UE.

In an example, the first UE is unable to obtain the discovery key from the mobile communication network, which includes: the first UE is disconnected from the mobile communication network in a case where the discovery key obtained from the mobile communication network is invalid.

In an example, the long-term key information includes the long-term key and/or the long-term key identifier of the long-term key.

A device for transmitting information is further provided according to an example of the present disclosure. As shown in FIG. 13, the device 300 is applied to a second UE of cellular mobile wireless communication, which includes:
a third transceiving module 310, configured to receive a ranging announcement message sent form a first UE on a direct link, where the ranging announcement message includes a long-term key identifier of a long-term key, the long-term key identifier is configured for second UE to determine an integrity protection key of the ranging announcement message, and the integrity protection key is configured to replace a discovery key for integrity protection of the ranging announcement message in a case where the first UE is unable to obtain the discovery key from a mobile communication network.

In an example, the ranging announcement message further includes a nonce.

The third transceiving module 310 is further configured to:
send the long-term key identifier and the nonce to a core network; and
receive an intermediate key that is sent from the core network via the mobile communication network in response to the long-term key identifier and the nonce.

The device 300 further includes: a third processing module 320, configured to determine the integrity protection key according to the intermediate key.

In an example, the third processing module 320 is further configured to:
perform integrity verification on the ranging announcement message according to the integrity protection key; and
determine whether to accept the ranging announcement message based on a result of the integrity verification.

In an example, the third transceiving module 310 is further configured to:
send a monitoring request at least carrying a ranging layer identifier of the second UE in a ranging layer to the core network; and
receive a second ranging application code sent from the core network in response to the monitoring request, where the second ranging application code is configured to indicate the ranging announcement message required to be monitored the second UE.

In an example, the third transceiving module 310 is further configured to:
send the long-term key identifier and the nonce to the core network in response to determining that a first ranging application code in the ranging announcement message and the second ranging application code have a correspondence relationship.

In an example, the ranging announcement message further includes at least one of:
a timestamp of when the first UE sends the ranging announcement message;
an identifier of an integrity protection algorithm for performing the integrity protection by using the integrity protection key; and
a ranging requirement.

In an example, the third processing module 320 is further configured to:
determine whether the ranging announcement message is replayed based on the timestamp and/or the nonce.

In an example, the first UE is unable to obtain the discovery key from the mobile communication network, which includes: the first UE is disconnected from the mobile communication network in a case where the discovery key obtained from the mobile communication network is invalid.

In an example, the first processing module 110, the first transceiving module 120, the second transceiving module 210, the second processing module 220, the third transceiving module 310, the third processing module 320 and the like may be implemented by one or more of a central processing unit (CPU), a graphics processing unit (GPU), a baseband processor (BP), an application specific integrated circuit (ASIC), a digital signal processor (DSP), a programmable logic device (PLD), a complex programmable logic device (CPLD), a field-programmable gate array (FPGA), a general-purpose processor, a controller, a micro controller unit (MCU), a microprocessor, or other electronic components, to execute the method.

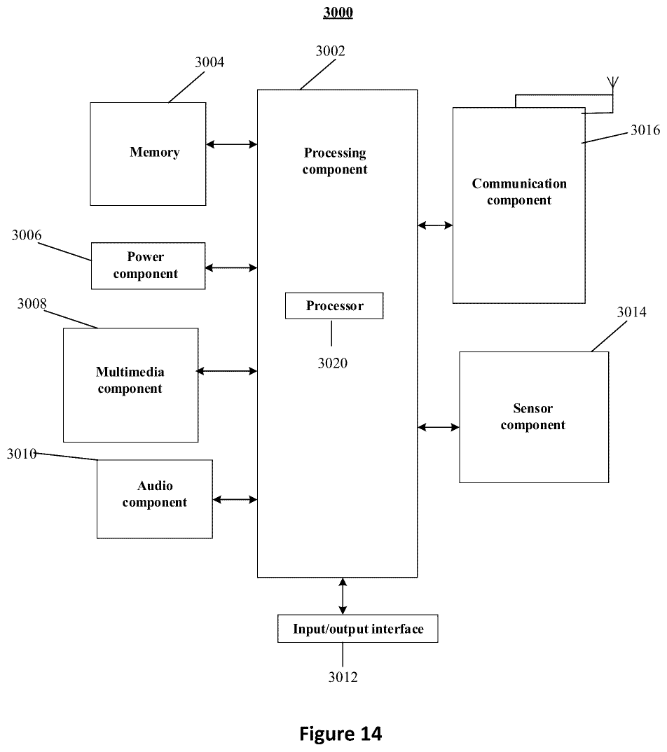

FIG. 14 is a block diagram of a device 3000 for transmitting information according to an example. For example, the device 3000 may be a mobile phone, a computer, a digital broadcast terminal, a messaging device, a gaming console, a tablet device, a medical device, a fitness device, a personal digital assistant, etc.

Referring to FIG. 14, the device 3000 may include one or more of a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the device 3000, for example, operations associated with display, phone calls, data communications, camera operations, and recording operations. The processing component 3002 may include one or more processors 3020 to execute instructions to complete all or some of steps of the method above. Moreover, the processing component 3002 may include one or more modules to facilitate interaction between the processing component 3002 and other components. For example, the processing component 3002 may include the multimedia module to facilitate interaction between the multimedia component 3008 and the processing component 3002.

The memory 3004 is configured to store various types of data to support an operation on the device 3000. Instances of such data include instructions operated on the device 3000 of any applications or methods, contact data, phonebook data, messages, pictures, video, etc. The memory 3004 may be implemented by any types of volatile or non-volatile memory devices or their combinations, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 3006 supplies power to the various components of the device 3000. The power component 3006 may include a power management system, one or more power supplies, and other components associated with power generation, management, and distribution for the device 3000.

The multimedia component 3008 includes a screen that provides an output interface between the device 3000 and the user. In some examples, the screen may include a liquid crystal display (LCD) and a touch panel (TP). In a case where the screen includes a touch panel, the screen may be implemented as a touch screen, to receive an input signal from a user. The touch panel includes one or more touch sensors to sense touches, slides, and gestures on the touch panel. The touch sensor may not only sense a boundary of a touch or swipe action, but also detect duration and pressure related to the touch or swipe operation. In some examples, the multimedia component 3008 includes a front-facing camera and/or a rear-facing camera. When the device 3000 is in an operational mode, for example, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio component 3010 is configured to output and/or input audio signals. For example, the audio component 3010 includes a microphone (MIC) configured to receive an external audio signal when the device 3000 is in the operational mode, for example, a calling mode, a recording mode, and a speech identification mode. The received audio signal may be further stored in the memory 3004 or sent via the communication component 3016. In some examples, the audio component 3010 further includes a speaker for outputting the audio signal.

The I/O interface 3012 provides an interface between the processing component 3002 and a peripheral interface module. The peripheral interface module may be a keyboard, a click wheel, a button, etc. These buttons may include, but are not limited to, a home button, a volume button, a start button, and a lock button.

The sensor component 3014 includes one or more sensors for providing status assessments of various aspects for the device 3000. For example, the sensor component 3014 may detect an on/off state of the device 3000 and relative positioning of the components. For example, the components are a display and a keypad of the device 3000. The sensor component 3014 may also detect a change in position of the device 3000 or a component of the device 3000, the presence or absence of contact between the user and the device 3000, orientation or acceleration/deceleration of the device 3000, and temperature variation of the device 3000. The sensor component 3014 may include a proximity sensor configured to detect the presence of a nearby object without any physical contact. The sensor component 3014 may also include a light sensor, for example, a complementary metal oxide semiconductor (CMOS) or charge coupled device (CCD) image sensor, for use in imaging applications. In some examples, the sensor component 3014 may further include an acceleration sensor, a gyroscope sensor, a magnetic sensor, a pressure sensor or a temperature sensor.

The communication component 3016 is configured to facilitate communication between the device 3000 and other device in a wired or wireless mode. The device 3000 may access a wireless network based on a communication standard, for example, Wi-Fi, 2G, or 3G, or their combinations. In an example, the communication component 3016 receives a broadcast signal or broadcast related information from an external broadcast management system via a broadcast channel. In an example, the communication component 3016 further includes a near field communication (NFC) module to facilitate short-range communication. For example, the NFC module may be implemented based on a radio frequency identification (RFID) technology, an infrared data association (IrDA) technology, an ultra-wide band (UWB) technology, a Bluetooth (BT) technology, or other technologies.

In an example, the device 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the method above.

In an example, a non-transitory computer-readable storage medium including instructions is further provided. For example, a memory 3004 including instructions. The instructions may be executed by the processor 3020 of the device 3000 to implement the method above. For example, the non-transitory computer-readable storage medium may be a read-only memory (ROM), a random access memory (RAM), a CD-ROM, a magnetic tape, a floppy disk, an optical data storage device, etc.

According to the method and device for transmitting information, the communication device, and the storage medium provided in the examples of the present disclosure, the first UE determines the integrity protection key RIK of the ranging announcement message according to the long-term key information sent from the core network, where the integrity protection key is configured to replace the discovery key for integrity protection of the ranging announcement message in a case where the first UE is unable to obtain the discovery key from a mobile communication network. In this way, through the long-term key information sent from the core network, the first UE may determine the integrity protection key by using the long-term key information when the integrity protection of the ranging announcement message cannot be performed by using the discovery key, thereby enabling the integrity protection of the ranging announcement message. As a result, a data transmission error or tampering of the range announcement message can be discovered in time in the transmission process, which improves the reliability of the transmission of the ranging announcement message.

Those skilled in the art would readily conceive other implementations of the embodiments of the present disclosure upon consideration of the specification and practice of the present disclosure here. The present disclosure is intended to cover any variations, uses, or adaptations of the embodiments of the present disclosure. These variations, uses, or adaptations comply with the general principles of the embodiments of the present disclosure, and include common knowledge or customary technical means in the art which are not disclosed herein. The specification and embodiments are to be considered illustrative merely, and the scope and spirit of the embodiments of the present disclosure are defined by the following claims.

It is to be understood that the embodiments of the present disclosure are not limited to the precise structure that has been described above and illustrated in the accompanying drawings, and that various modifications and changes can be made without departing from the scope thereof. The scope of the embodiments of the present disclosure is merely limited by the appended claims.

1. A method for transmitting information, performed by a first user equipment (UE), comprising:
determining an integrity protection key of a ranging announcement message according to long-term key information sent from a core network,
wherein the integrity protection key is configured to replace a discovery key for integrity protection of the ranging announcement message in a case where the first UE is unable to obtain the discovery key from a mobile communication network.

2. The method according to claim 1, wherein determining the integrity protection key of the ranging announcement message according to the long-term key information sent from the core network comprises:
determining an intermediate key based on a long-term key determined by the long-term key information and a nonce; and
determining the integrity protection key according to the intermediate key.

3. The method according to claim 2, further comprising:
sending, on a direct link, the ranging announcement message with the integrity protection using the integrity protection key, wherein the ranging announcement message at least comprises a long-term key identifier of the long-term key and the nonce, and the long-term key identifier is determined according to the long-term key information.

4. The method according to claim 3, wherein sending, on the direct link, the ranging announcement message with the integrity protection using the integrity protection key comprises:
sending the ranging announcement message with the integrity protection using the integrity protection key in response to determining that the first UE fails to be connected to the mobile communication network.

5. The method according to claim 2, wherein the ranging announcement message further comprises at least one of:
a timestamp of when the first UE sends the ranging announcement message;
an identifier of an integrity protection algorithm for performing the integrity protection by using the integrity protection key; and/or
a ranging requirement.

6. The method according to claim 1, wherein the ranging announcement message further comprises a first ranging application code, and the first ranging application code is configured to identify the ranging announcement message; or
the long-term key information comprises a long-term key and/or a long-term key identifier of the long-term key.

7. The method according to claim 1, wherein the case where the first UE is unable to obtain the discovery key from the mobile communication network comprises:
the first UE is disconnected from the mobile communication network in a case where the discovery key obtained from the mobile communication network is invalid.

8. (canceled)

9. A method for transmitting information, performed by a core network, comprising:
sending long-term key information to a first UE,
wherein the long-term key information is configured for the first UE to determine an integrity protection key of a ranging announcement message, and the integrity protection key is configured to replace a discovery key for integrity protection of the ranging announcement message in a case where the first UE is unable to obtain the discovery key from a mobile communication network.

10. The method according to claim 9, wherein
the method further comprises:
receiving a long-term key identifier and a nonce sent from a second UE via the mobile communication network;
determining an intermediate key based on a long-term key corresponding to the long-term key identifier and the nonce; and
sending the intermediate key to the second UE via the mobile communication network; or
the method further comprises:
receiving a monitoring request sent from the second UE via the mobile communication network, wherein the monitoring request at least carrying a ranging layer identifier of the second UE; and
sending a second ranging application code to the second UE via the mobile communication network in response to determining that the second UE is allowed to monitor the ranging announcement message based on an application layer rule, wherein the second ranging application code is configured to indicate the ranging announcement message required to be monitored by the second UE.

11. The method according to claim 9, wherein sending the long-term key information to the first UE comprises:
sending the long-term key information to the first UE via the mobile communication network in response to determining that the first UE has a ranging layer identifier corresponding to the first UE in a ranging layer.

12. (canceled)

13. The method according to claim 9, wherein the case where the first UE is unable to obtain the discovery key from the mobile communication network comprises:
the first UE is disconnected from the mobile communication network in a case where the discovery key obtained from the mobile communication network is invalid.

14. The method according to claim 9, wherein the long-term key information comprises a long-term key and/or a long-term key identifier of the long-term key.

15. A method for transmitting information, performed by a second UE, comprising:
receiving a ranging announcement message sent from a first UE on a direct link,
wherein the ranging announcement message comprises a long-term key identifier of a long-term key, the long-term key identifier is configured for the second UE to determine an integrity protection key of the ranging announcement message, and the integrity protection key is configured to replace a discovery key for integrity protection of the ranging announcement message in a case where the first UE is unable to obtain the discovery key from a mobile communication network.

16. The method according to claim 15, wherein the ranging announcement message further comprises a nonce, and the method further comprises:
sending the long-term key identifier and the nonce to a core network;
receiving an intermediate key that is sent from the core network via the mobile communication network in response to the long-term key identifier and the nonce; and
determining the integrity protection key according to the intermediate key.

17. The method according to claim 16, wherein
the method further comprises:
performing integrity verification on the ranging announcement message according to the integrity protection key; and
determining whether to accept the ranging announcement message based on a result of the integrity verification; or
the method further comprises:
sending a monitoring request at least carrying a ranging layer identifier of the second UE in a ranging layer to the core network; and
receiving a second ranging application code sent from the core network in response to the monitoring request, wherein the second ranging application code is configured to indicate the ranging announcement message required to be monitored by the second UE; or
the method further comprises:
determining whether the ranging announcement message is replayed based on a timestamp of when the first UE sends the ranging announcement message and/or the nonce.

18. (canceled)

19. The method according to claim 16, wherein the method further comprises:
sending a monitoring request at least carrying a ranging layer identifier of the second UE in a ranging layer to the core network; and receiving a second ranging application code sent from the core network in response to the monitoring request, wherein the second ranging application code is configured to indicate the ranging announcement message required to be monitored by the second UE:
wherein sending the long-term key identifier and the nonce to the core network comprises:
sending the long-term key identifier and the nonce to the core network in response to determining that a first ranging application code in the ranging announcement message and the second ranging application code have a correspondence relationship.

20. The method according to claim 16, wherein the ranging announcement message further comprises at least one of:
a timestamp of when the first UE sends the ranging announcement message;
an identifier of an integrity protection algorithm for performing the integrity protection by using the integrity protection key; or
a ranging requirement.

21. (canceled)

22. The method according to claim 15, wherein the case where the first UE is unable to obtain the discovery key from the mobile communication network comprises:
the first UE is disconnected from the mobile communication network in a case where the discovery key obtained from the mobile communication network is invalid.

23.-25. (canceled)

26. A communication device, comprising:
one or more processors;
a memory; and
an executable program stored on the memory wherein
the executable program when collectively executed by the one or more processors cause the communication device to perform the method for transmitting information according to claim 1.

27. (canceled)

28. A communication device, comprising:
one or more processors;
a memory; and
an executable program stored on the memory and executed by the one or more processors, wherein
the executable program when collectively executed by the one or more processors cause the communication device to perform the method for transmitting information according to claim 15.
